(19) United States
(12) Patent Application Publication
(10) Pub. No.: US 2026/0187896 A1
(43) Pub. Date: Jul. 2, 2026

(54) INFORMATION PROCESSING SYSTEM, SERVER, INFORMATION PROCESSING METHOD, AND NON-TRANSITORY RECORDING MEDIUM

(71) Applicant: Naoki MOTOHASHI, Kanagawa (JP)

(72) Inventor: Naoki MOTOHASHI, Kanagawa (JP)

(21) Appl. No.: 19/419,214

(22) Filed: Dec. 15, 2025

(30) Foreign Application Priority Data
Dec. 27, 2024 (JP) 2024-232452

(51) Int. Cl. G06T 15/00; G06T 1/60

(52) U.S. Cl. CPC G06T 15/00; G06T 1/60

(57) ABSTRACT

An information processing system includes a first server that manages text data generated based on audio data obtained with a captured image of an object, a second server that manages three-dimensional image information of the object and the captured image aligned with the three-dimensional image information, and a terminal to display, on a screen, the text data and the three-dimensional image information received from the first server and the second server, respectively. The second server identifies the captured image based on a field of view of the three-dimensional image information selected at the terminal, obtains, from the first server, the text data, associates the three-dimensional image information corresponding to the field of view with one of the text data and information generated based on the text data. The terminal displays, on the screen, the three-dimensional image information and the one of the text data and the generated information.

### CROSS-REFERENCE TO RELATED APPLICATION

This patent application is based on and claims priority pursuant to 35 U.S.C. § 119(a) to Japanese Patent Application No. 2024-232452, filed on Dec. 27, 2024, in the Japan Patent Office, the entire disclosure of which is hereby incorporated by reference herein.

### BACKGROUND

### Technical Field

The present disclosure relates to an information processing system, a server, an information processing method, and a non-transitory recording medium.

### Related Art

In some cases, a first server and a second server manage pieces of information associated with each other. A terminal device displays information managed by the first server and information managed by the second server.

In a system, such a communication terminal displays information related to a property transmitted from a link information management system and a spherical image of the property transmitted from an image management system.

### SUMMARY

The present disclosure described herein provides an information processing system including a first server, a second server, and a terminal device. The first server manages text data generated based on audio data obtained along with a captured image of a target object. The captured image is obtained by an image capturing device. The first server includes first server circuitry. The second server manages three-dimensional image information of the target object and the captured image aligned with the three-dimensional image information. The second server including second server circuitry. The terminal device communicates with the first server and the second server. The terminal device includes terminal device circuitry to display, on a display screen, the text data received from the first server and the three-dimensional image information received from the second server. The second server circuitry identifies the captured image based on a field of view of the three-dimensional image information. The field of view is selected at the terminal device. The second server circuitry obtains, from the first server, the text data obtained along with the captured image. The second server circuitry associates the three-dimensional image information corresponding to the field of view with one of the text data and generated information that is generated based on the text data. The terminal device circuitry displays, on the display screen, the three-dimensional image information and the one of the text data and the generated information in association with each other. The three-dimensional image information and the one of the text data and the generated information is received from the second server.

The present disclosure described herein provides a server including circuitry to store, in a memory, three-dimensional image information of a target object and a captured image aligned with the three-dimensional image information. The captured image is obtained by an image capturing device. The circuitry identifies the captured image based on a field of view of the three-dimensional image information. The field of view is selected by a terminal device connected to the server. The circuitry obtains, from another server, text data obtained along with the captured image by the image capturing device, associates the three-dimensional image information corresponding to the field of view with one of the text data and generated information that is generated based on the text data, and transmits, to the terminal device, the three-dimensional image information and the one of the text data and the generated information. The three-dimensional image information and the one of the text data and the generated information are to be displayed in association with each other on a display screen of the terminal device.

The present disclosure described herein provides an information processing method performed by a server. The method includes storing, in a memory, three-dimensional image information of a target object and a captured image aligned with the three-dimensional image information. The captured image is obtained by an image capturing device. The method includes identifying the captured image based on a field of view of the three-dimensional image information. The field of view is selected at a terminal device connected to the server. The method includes obtaining, from another server, text data, the text data being obtained along with the captured image by the image capturing device. The method includes associating the three-dimensional image information corresponding to the field of view with one of the text data and generated information that is generated based on the text data, and transmitting, to the terminal device, the three-dimensional image information and the one of the text data and the generated information. The three-dimensional image information and the one of the text data and the generated information are to be displayed in association with each other on a display screen of the terminal device.

The present disclosure described herein provides a non-transitory recording medium storing a plurality of instructions which, when executed by one or more processors, causes the one or more processors to perform a method. The method includes storing, in a memory, three-dimensional image information of a target object and a captured image aligned with the three-dimensional image information. The captured image is obtained by an image capturing device. The method includes identifying the captured image based on a field of view of the three-dimensional image information. The field of view is selected at a terminal device connected to the server. The method includes obtaining, from another server, text data, the text data being obtained along with the captured image by the image capturing device. The method includes associating the three-dimensional image information corresponding to the field of view with one of the text data and generated information that is generated based on the text data, and transmitting, to the terminal device, the three-dimensional image information and the one of the text data and the generated information. The three-dimensional image information and the one of the text data and the generated information are to be displayed in association with each other on a display screen of the terminal device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an information processing system;

FIG. 2 is a block diagram illustrating a hardware configuration of an image management server, a meeting management server, or a terminal device;

FIG. 3 is a block diagram illustrating functional configurations of a three-dimensional image management server, a meeting management server, and a terminal device in an information processing system;

FIG. 4 is a conceptual diagram of a three-dimensional image information management table;

FIG. 5 is a conceptual diagram of a captured image information management table;

FIG. 6 is a conceptual diagram of a meeting information management table;

FIG. 7 is a sequence diagram illustrating a process of communicating a wide-field image and audio data;

FIGS. 8A and 8B are diagrams illustrating display screens on a terminal device in a model update process and a text information generation process, respectively;

FIGS. 9A and 9B are diagrams illustrating display screens on a terminal device in a model update process and a text information generation process, respectively;

FIG. 10 is a sequence diagram illustrating a process of generating screen information in which an audio transcript and one of a captured image and three-dimensional image information are arranged, as the process based on the audio transcript and the one of the captured image and the three-dimensional image information;

FIG. 11 is a diagram illustrating an example of a property specification screen;

FIG. 12 is a diagram illustrating an example of an audio transcript display screen;

FIG. 13 is a diagram illustrating an example of a text and image display screen;

FIG. 14 is a diagram illustrating an example of a past audio transcript and past captured image display screen;

FIG. 15 is a diagram illustrating a past audio transcript and past captured image display screen on which another audio transcript is selected by a user;

FIG. 16 is a sequence diagram illustrating a process of generating screen information in which an audio transcript and one of a captured image and three-dimensional image information are arranged, as the process based on the audio transcript and the one of the captured image and the three-dimensional image information;

FIG. 17 is a sequence diagram illustrating a model update process;

FIG. 18 is a diagram illustrating an example of a text and image display screen displayed on the terminal device;

FIG. 19 is a sequence diagram illustrating a process of generating text information;

FIG. 20 is a diagram illustrating an example of the text and image display screen in an inference phase;

FIG. 21 is a diagram illustrating an example of a past audio transcript and past captured image display screen on which text information is displayed;

FIG. 22 is a block diagram illustrating functional configurations of a three-dimensional image management server, a meeting management server, and a terminal device in an information processing system;

FIG. 23 is a sequence diagram illustrating a process of generating text information and image information; and

FIG. 24 is a diagram illustrating generated image information displayed on a past audio transcript and past captured image display screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an information processing method performed by the information processing system are described below with reference to the drawings.

Supplemental Description of Tacit Knowledge In industries such as civil engineering and construction, the implementation of building information modeling (BIM)/construction information modeling (CIM) has been promoted to address challenges such as a declining birthrate and aging population, as well as enhancing labor productivity.

BIM refers to a solution that utilizes a database of buildings, in which a three-dimensional digital model generated on a computer is supplemented with attribute data, such as cost, finishes, and management information. This solution enables the effective use of information throughout all phases of a building's lifecycle, including design, construction, and subsequent maintenance and management. The three-dimensional digital model may be referred to as a 3D model in the following description.

CIM is a solution that has been proposed for the field of civil engineering (widely covering infrastructure such as roads, electricity, gas, and water supply), following BIM that has been advanced in the field of construction. Similar to BIM, CIM is implemented to enhance and streamline the entire construction production system by information sharing among stakeholders through the use of 3D models as a central platform.

In promoting BIM and CIM, a point is how to utilize the constructed BIM and CIM.

Specifically, the 3D models reconstructed through BIM and CIM can be utilized not only for design and construction purposes, but also for other tasks such as maintenance and management operations and site inspections. In other words, 3D models can be used for other purposes, such as recording information in the models and sharing information with other stakeholders in addition to design drawings.

Since operations performed on the 3D model can be recorded as logs, tacit knowledge extracted from these records may be effectively utilized for purposes such as transferring skills and expertise from experienced personnel to younger or less experienced workers. This is expected to contribute to, for example, front-loading of operations and the development of human resources.

Focusing on the transfer of tacit knowledge, it becomes a challenge not only in the context of 3D models but also when using 2D data, such as omnidirectional images or planar images, to effectively convey such tacit knowledge across different tasks and between users with varying levels of expertise.

Specifically, since tacit knowledge is qualitative in nature and difficult to quantify, even if a tacit knowledge model is generated from tacit knowledge, it is challenging to ensure user trust in the tacit knowledge model. As a result, promoting the use of such tacit knowledge models has been difficult. For example, if the domain of expertise of the tacit knowledge model differs from the domain of expertise of the user, then no matter how sophisticated the model may be, the tacit knowledge model holds little to no value for the user. Similarly, if the knowledge level of the tacit knowledge model is lower than the knowledge level of the user, the tacit knowledge model holds little to no value for the user.

However, it is also true that tacit knowledge models can provide users with new perspectives and insights. By utilizing such models, even users with limited experience have the potential to acquire operational expertise and technical capabilities and to apply the acquired operational expertise and technical capabilities effectively in their tasks.

In addition, for a system including a first server that stores an audio transcript obtained during a meeting regarding a property, there are demands of adding the functions of displaying at least one of a three-dimensional image such as 3D models corresponding to the property and a captured image obtained during the meeting.

This may be achieved by configuring the first server to acquire the at least one of a three-dimensional image such as 3D models corresponding to the property and a captured image obtained during the meeting. However, adding such a function to the first server will increase the cost.

According to one aspect of the present disclosure, the second server executes a process based on at least one of the audio transcript managed by the first server and the three-dimensional image information or the captured image managed by the second server. This process includes displaying the audio transcript managed by the first server and at least one of the three-dimensional image information and the captured image managed by the second server on a single screen.

The second server can also cause the terminal device to display tacit knowledge (e.g., text information) about the property generated based on at least one of the captured image and the three-dimensional image information in association with the three-dimensional image information or the captured image, in addition to causing the terminal device to simply display the two pieces of information. This allows the terminal device to display at least one of the three-dimensional image information and the captured image in association with the audio transcript on a single screen, or to display the tacit knowledge about the item in association with at least one of the three-dimensional image information and the captured image without adding a processing function to the first server.

### Terms

The term “user” refers to a person who uses text information or non-text content, such as images, generated or output by a tacit knowledge model. The term “data provider” refers to a person who provides data to be used by the tacit knowledge model for learning, such as audio information, text information, operation information, images, and 3D data.

The term “tacit knowledge” refers to knowledge based on, for example, personal experience and intuition. The term “tacit knowledge model” refers to a model that learns tacit knowledge and outputs responses to questions based on the learned tacit knowledge. The term “model” refers to a mechanism or artificial intelligence (AI) that learns the correspondence between input data and output data, and outputs data in response to the input data. The output data is generated regardless of the presence of learning data.

The term “property” refers to any space in which an item can be placed, such as a facility or a room in a facility. The term “item” refers to an item that is placed in a property. The type of item to be placed varies depending on the function of the facility.

Examples of such properties include, but are not limited to, real estate, industrial plants, construction sites, research institutions, healthcare facilities, agricultural land, storage facilities, and other infrastructure requiring maintenance and management. Examples of such items include, but are not limited to, furniture, construction materials, equipment, heavy machinery, tools, instruments, raw materials, biological cultures, and food products.

The term “three-dimensional image information of an item” refers to an image obtained by capturing a 3D model by a virtual camera. The three-dimensional image information allows the user to change the viewpoint.

The term “generated information” refers to information generated based on three-dimensional image information and a captured image. The generated information may be generated by a tacit knowledge model. In the following description, the generated information is referred to as a tacit knowledge comment or text information.

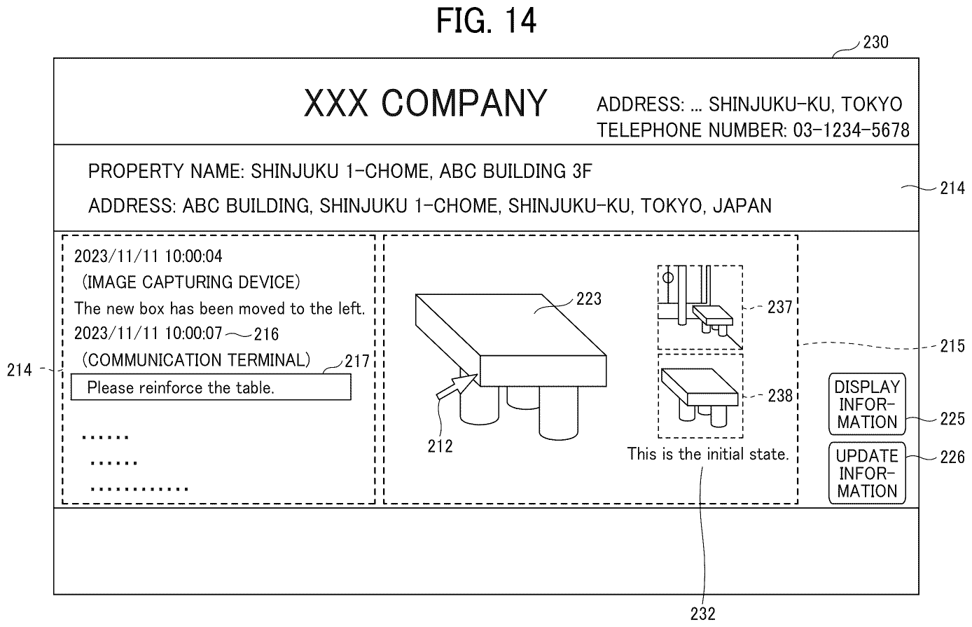

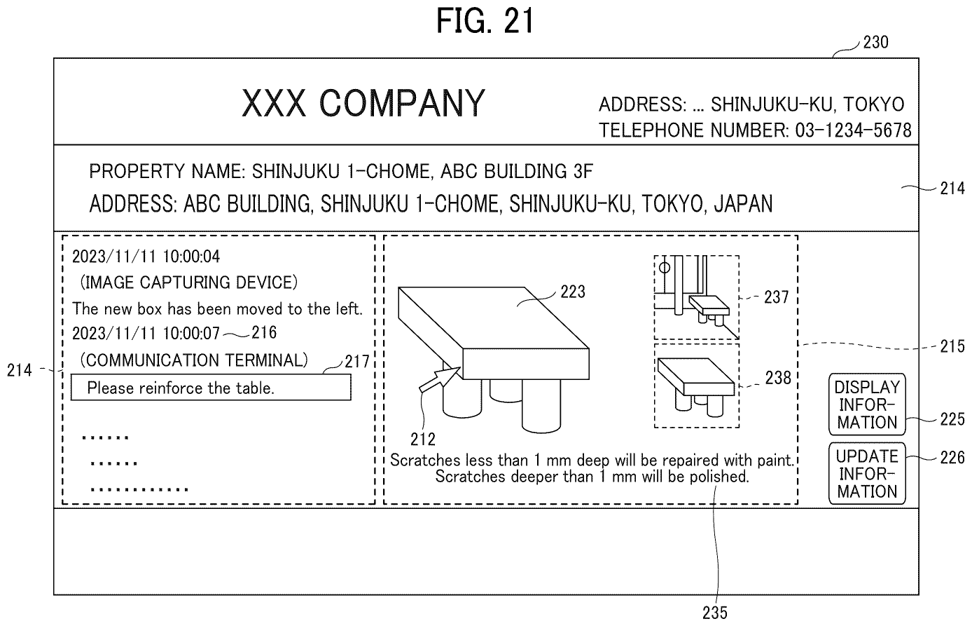

The term “display screen” refers to, for example, a single screen on which an audio transcript and one of a captured image and three-dimensional image information is displayed or generated information and one of a captured image and three-dimensional image information is displayed. FIGS. 14 and 21 each illustrate a display screen.

The term “wide-field image” refers to an image with a capture range that extends beyond the standard field of view. For example, the wind-field image is an image with a capture range with a wide-field of view and includes a 360-degree image capturing the full surroundings. The 360-degree image may be also referred to as a spherical image, an omnidirectional image, or an all-round image.

The term “predetermined-area image” refers to an image corresponding to a predetermined area that is a part of a wide-field image. The predetermined-area image is projected on a two-dimensional plane and is a planar image. In the following description, the predetermined-area image stored by a capturing operation is referred to as a “captured image”.

### First Embodiment

### System Configuration

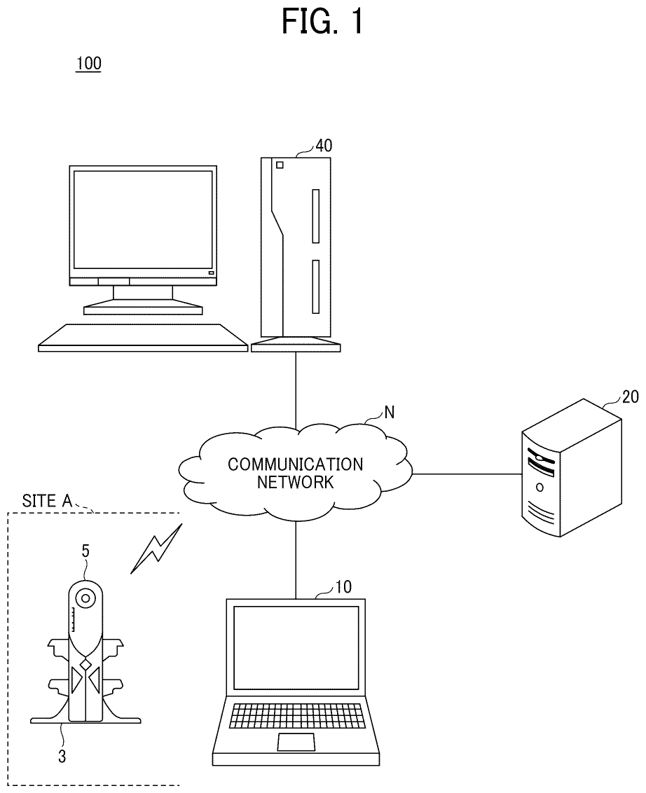

FIG. 1 is a schematic diagram of an information processing system 100. The information processing system 100 includes a terminal device 10, an image capturing device 5, an image management server 40, and a meeting management server 20. The terminal device is an example of an input and output device. Alternatively, the information processing system 100 may not include the terminal device 10 provided that the terminal device 10 is connected to the image management server 40 or the meeting management server 20 when needed.

The image management server 40, which is an example of a second server, is one or more information processing apparatuses that communicate with the terminal device 10 via a communication network N. The image management server 40 manages three-dimensional image information of a property and a captured image and has a tacit knowledge model and a large-scale language model. The image management server 40 uses these resources to return text information including tacit knowledge to the user. The image management server 40 may be a web server that returns a processing result to the terminal device 10 in response to a request from the terminal device 10. The server is a computer or software that functions to provide information or a processing result in response to a request from a client.

The image management server 40 may support cloud computing. The term “cloud computing” refers to internet-based computing where resources on a network are used or accessed without identifying specific hardware resources. Cloud computing may take any form, including Software as a Service (SaaS), Platform as a Service (PaaS), or Infrastructure as a Service (IaaS). For this reason, the image management server 40 does not need to be housed in a single housing or provided as a single apparatus. The functions of the image management server 40 may be allocated among multiple information processing apparatuses. Alternatively, each of the multiple information processing apparatuses may have all the functions, with processing being switched among the information processing apparatuses based on load balancing or similar mechanisms. The image management server 40 may be a server residing in an on-premises environment.

Instead of the image management server 40 having the tacit knowledge model and the large-scale language model, the image management server 40 may call an application programming interface (API) published by an external system and use at least one of the tacit knowledge model and the large-scale language model.

The meeting management server 20, which is an example of a first server, is one or more information processing apparatuses that communicate with the terminal device 10 via the communication network N. The meeting management server 20 manages audio transcript of comments made during a meeting regarding a property. The meeting management server 20 may or may not have image information. In a case where the meeting management server 20 has image information, the image information is merely, for example, a photograph different from an image managed by the image management server 40.

The meeting management server 20 may be a web server that returns a processing result to the terminal device 10 in response to a request from the terminal device 10. The meeting management server 20 communicates with the image management server 40 via the communication network N. The meeting management server 20 may support either cloud computing or on-premises environments.

Preferably, the image management server 40 and the meeting management server 20 are integrated enough to support single sign-on. The image management server 40 communicates with the meeting management server 20 via an API exposed by the meeting management server 20. Alternatively, the image management server 40 and the meeting management server 20 may be integrated or linked for operational purposes.

The terminal device 10 is a general-purpose information processing terminal used by a user of the information processing system 100. On the terminal device 10, a web browser and a native application dedicated to the image management server 40 or the meeting management server 20 operate. In a case where the terminal device 10 executes a web browser, the terminal device 10 and the image management server 40 or the meeting management server 20 execute a web application.

Specifically, the web application is an application that operates through the cooperation of a program written in a programming language (e.g., JAVASCRIPT) running on a web browser and a program running on a web server (e.g., the image management server 40). When the web application is executed, processing may be performed by the image management server 40 or the meeting management server 20, or by the terminal device 10 that has received the web application.

An application that is not executed unless installed in the terminal device 10 is referred to as a native application. The application executed by the terminal device 10 may be a web application or a native application. In this case, processing may be performed by the image management server 40 or the terminal device 10 that executes the native application.

The terminal device 10 is, for example, a personal computer (PC), a smartphone, a personal digital assistant (PDA), or a tablet terminal. The terminal device 10 may be any other device on which a web browser or a native application operates. The terminal device 10 may be an electronic whiteboard, a television receiver, a smart glass device, or a wearable device. Multiple terminal devices 10 may be present.

The terminal device 10 communicates with image management server 40 and the meeting management server 20 via the communication network N. The communication network N is implemented by, for example, the Internet, a local area network (LAN), or a provider service. The communication network N may include not only wired communication but also mobile communication networks in compliance with, for example, 3rd Generation Mobile Communication System (3G), Worldwide Interoperability for Microwave Access (WiMAX), or Long-Term Evolution (LTE), and networks using wireless LANs. The terminal device 10 can establish communication by a short-range communication technology, such as BLUETOOTH or near field communication (NFC).

The image capturing device 5 is a digital camera to acquire wide-field images or record audio.

The image capturing device 5 connects to the communication network N via the relay device 3. The relay device 3 has a cradle function for charging the image capturing device 5 and transmitting and receiving data to and from the image capturing device 5. The relay device 3 can communicate with the image capturing device 5 via a contact point and can communicate with the meeting management server 20 via the communication network N. The image capturing device 5 and the relay device 3 are installed at predetermined positions on a site Sa such as a construction site, exhibition venue, educational institution, or medical facility. The image capturing device 5 may also be a digital camera that obtains regular narrow-field images, such as a single-lens reflex camera. The meeting management server 20 may also stream live images of a narrow-field image captured by the image capturing device 5. In this case, the predetermined-area image is an image corresponding to all or part of a predetermined area of the captured image.

In FIG. 1, the image management server 40, the meeting management server 20, and the terminal device 10 communicate with each other via the communication network N. However, the user may directly operate the image management server 40 or the meeting management server 20 from the control panel.

### Hardware Configuration

### Image Management Server, Meeting Management Server, Terminal Device

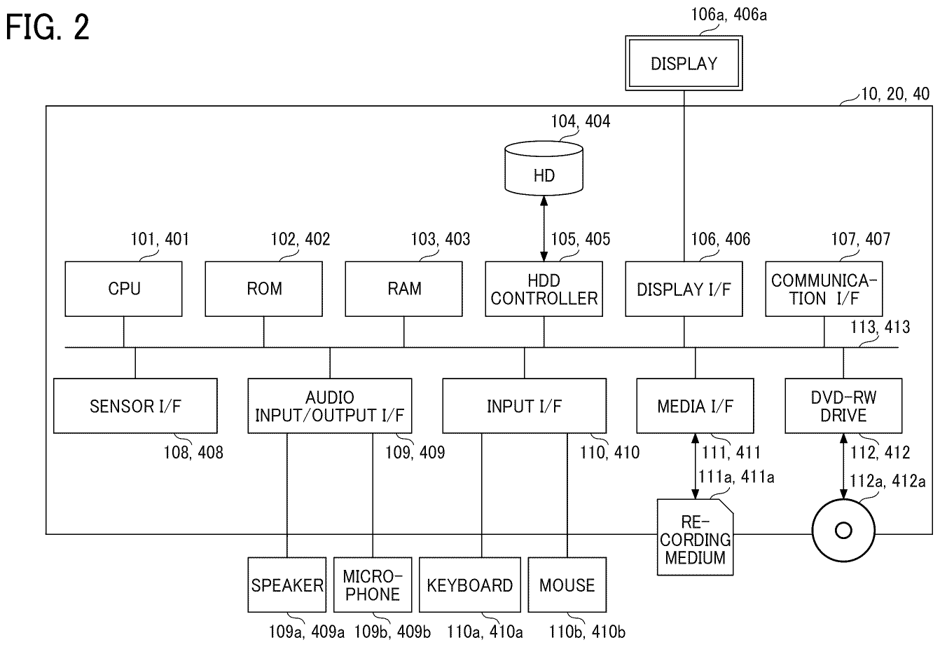

FIG. 2 is a block diagram illustrating a hardware configuration applicable to each of the image management server 40, the meeting management server 20, and the terminal device 10. Each hardware component of the image management server 40 or the meeting management server 20 is denoted by a reference numeral in the 400s. Each hardware component of the terminal device 10 is denoted by a reference numeral in the 100s.

The hardware configuration of the terminal device 10 is described below. Since the hardware configuration of the image management server 40 or the meeting management server 20 is the same as that of the terminal device 10, the description thereof will be omitted.

The terminal device 10 is implemented by a computer. As illustrated in FIG. 2, the terminal device 10 includes a central processing unit (CPU) 101, a read-only memory (ROM) 102, a random-access memory (RAM) 103, a hard disk (HD) 104, a hard disk drive (HDD) controller 105, a display interface (I/F) 106, and a communication I/F 107.

The CPU 101 controls the overall operation of the terminal device 10. The ROM 102 stores a program such as an initial program loader (IPL) used for booting the CPU 101. The RAM 103 is used as a work area for the CPU 101.

The HD 104 stores various data such as a control program. The HDD controller 105 controls the reading or writing of various data from or to the HD 104 under the control of the CPU 101.

The display I/F 106 is a circuit to control a display 106a to display an image.

The display 106a is an example of a display unit, such as a liquid crystal display or an organic electroluminescence (EL) display that displays various types of information, such as the cursor, menus, windows, text, or images. The communication I/F 107 is an interface used for communication with another device (external device).

When the terminal device 10 is a glass device, the terminal device 10 may use a circuit that causes a lens as a transmissive reflective member to display an image in an alternative to the display I/F 106.

The communication I/F 107 is, for example, a network interface card (NIC) in compliance with transmission control protocol/internet protocol (TCP/IP).

The terminal device 10 further includes a sensor I/F 108, an audio input/output I/F 109, an input I/F 110, a media I/F 111, and a digital versatile disk rewritable (DVD-RW) drive 112.

The sensor I/F 108 is an interface that receives information detected by various sensors. The audio input/output I/F 109 is a circuit that processes the input of audio signals from a microphone 109b and the output of audio signals to a speaker 109a under the control of the CPU 101. The input I/F 110 is an interface for connecting an input device to the terminal device 10.

A keyboard 110a is a type of input device equipped with multiple keys used for entering, for example, characters, numbers, and various commands. A mouse 110b is a type of input device that enables, for example, the selection and execution of various commands, the selection of processing targets, the movement of the cursor, or operations on a display screen.

The media I/F 111 controls the reading or writing (storage) of data to or from a recording medium 111a, such as flash memory. The DVD-RW drive 112 controls the reading or writing of various data to or from a DVD-RW 112a, which is an example of a removable recording medium. The removable recording medium is not limited to the DVD-RW. For example, the removable recording medium may be a DVD-recordable (DVD-R). Further, the DVD-RW drive 112 may be a BLU-RAY drive to control the reading or writing of various data to or from a BLU-RAY disc.

The terminal device 10 further includes a bus line 113. The bus line 113 includes an address bus and a data bus and electrically connects components such as the CPU 101 to each other.

Recording media, such as HDs or compact disc read-only memories (CD-ROMs) on which the above-mentioned programs are stored, may be provided as program products, either domestically or internationally. The terminal device 10 implements an information processing method by, for example, executing a program.

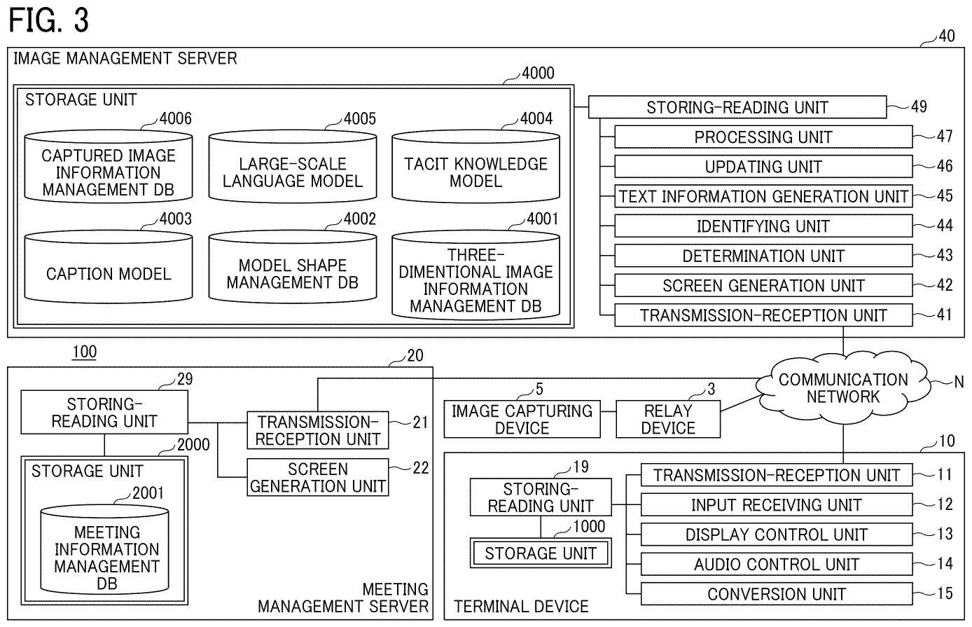

Functions FIG. 3 is a block diagram illustrating functional configurations of the image management server 40, the meeting management server 20, and the terminal device 10 in the information processing system 100. Each of the image capturing device 5 and the relay device 3 is assumed to have functions already known.

Terminal Device As illustrated in FIG. 3, the terminal device 10 includes a transmission-reception unit 11, an input reception unit 12, a display control unit 13, an audio control unit 14, a conversion unit 15, and a storing-reading unit 19. These functional units are functions or means of functioning that are implemented by the operation of one or more hardware components illustrated in FIG. 2 in response to instructions from the CPU 101, based on a program loaded from the HD 104 to the RAM 103. The terminal device 10 further includes a storage unit 1000, which is implemented by at least one of the RAM 103 and the HD 104 illustrated in FIG. 2.

The transmission-reception unit 11 is an example of a transmission unit or a reception unit and implemented by instructions from the CPU 101 illustrated in FIG. 2, as well as the communication I/F 107 illustrated in FIG. 2. The transmission-reception unit 11 transmits and receives various data (or information) to and from another terminal, device, apparatus, or system via the communication network N.

The input reception unit 12, which is an example of an input reception unit, is implemented by instructions from the CPU 101 illustrated in FIG. 2, as well as by the input I/F 110 and the audio input/output I/F 109 illustrated in FIG. 2. The input reception unit 12 receives various inputs from the user via the microphone 109b, the keyboard 110a, or the mouse 110b illustrated in FIG. 2.

The display control unit 13, which is an example of a display control unit and an output unit, is implemented by instructions from the CPU 101 illustrated in FIG. 2 and the display I/F 106 illustrated in FIG. 2. The display control unit 13 causes the display 106a, which is an example of a display unit, to display various images and screens. When the terminal device 10 is a glass device, the display control unit 13 causes virtual images to be displayed on a transmissive and reflective member, such as a lens, in place of the display I/F 106.

The audio control unit 14, which is an example of an audio control unit and an output unit, is implemented by instructions from the CPU 101 illustrated in FIG. 2 and the audio input/output I/F 109 illustrated in FIG. 2. The audio control unit 14 causes sound to be reproduced through the speaker 109a, which is an example of an audio reproduction unit.

The conversion unit 15, which is an example of a processing unit, is implemented by instructions from the CPU 101 illustrated in FIG. 2. The conversion unit 15 performs processing for converting text information into audio information, and processing for converting audio information into text information.

The storing-reading unit 19 is an example of a storing control unit and implemented by instructions from the CPU 101 illustrated in FIG. 2, as well as the HD 104, the media I/F 111, and the DVD-RW drive 112 illustrated in FIG. 2. The storing-reading unit 19 stores various data or retrieves various data in or from the storage unit 1000, the recording medium 111a, and the DVD-RW 112a.

### Functional Configuration of Image Management Server

The image management server 40 includes a transmission-reception unit 41, a screen generation unit 42, a determination unit 43, an identification unit 44, a text information generation unit 45, an update unit 46, a processing unit 47, and a storing-reading unit 49.

These functional units are functions or means of functioning that are implemented by the operation of one or more hardware components illustrated in FIG. 2 in response to instructions from the CPU 401, based on a program loaded from the HD 404 to the RAM 403. The image management server 40 further includes a storage unit 4000, which is implemented by the HD 404 in FIG. 2. The storage unit 4000 is an example of a memory (storage means).

In FIG. 3, all the functions are implemented on the single image management server 40. Alternatively, the image management server 40 may be configured such that the functions are distributed across multiple computers.

The transmission-reception unit 41 is an example of a transmission unit or a reception unit and is implemented by instructions from the CPU 401 illustrated in FIG. 2 as well as the communication I/F 407 illustrated in FIG. 2. The transmission-reception unit 41 transmits and receives various data (or information) to and from another terminal, device, apparatus, or system via the communication network N.

The screen generation unit 42, which is an example of a screen generation unit, is implemented by instructions from the CPU 401 illustrated in FIG. 2. The screen generation unit 42 generates various screens. In a case where the terminal device 10 executes a web application, the screen information is generated in a format of, for example, HyperText Markup Language (HTML), eXtensible Markup Language (XML), Cascading Style Sheets (CSS), or JAVASCRIPT. For this reason, the screen information may be referred to as a web application. In a case where the terminal device 10 executes a client application, the screen information is held by the terminal device 10, and the screen information representing the screen to be displayed is transmitted in a format of, for example, XML.

The determination unit 43, which is an example of a determination unit, is implemented by instructions from the CPU 401 illustrated in FIG. 2. The determination unit 43 performs various determinations described later.

The identification unit 44, which is an example of an identification unit, is implemented by instructions from the CPU 401 illustrated in FIG. 2. The identification unit 44 identifies a target image.

The text information generation unit 45, which is an example of a text information generation unit, is implemented by instructions from the CPU 401 illustrated in FIG. 2. The text information generation unit 45 acquires tacit knowledge comments from a tacit knowledge model or generates text information based on a large-scale language model 4005.

The update unit 46, which is an example of an update unit, is implemented by instructions from the CPU 401 illustrated in FIG. 2. The update unit 46 updates a tacit knowledge model described later.

The processing unit 47 performs association processing for associating three-dimensional image information or a captured image with an audio transcript, or associating three-dimensional image information or a captured image with generated information (an example of text information) generated from the three-dimensional image information and the captured image, in accordance with processing requested by the user. The association processing includes displaying, on a single screen, three-dimensional image information or a captured image with an audio transcript, or three-dimensional image information or a captured image with generated information. Additionally, the association processing includes obtaining generated information, which is an example of text information, from the tacit knowledge model 4004 using three-dimensional image information and a captured image. The processing unit 47 requests, for example, the screen generation unit 42 or the text information generation unit 45 to perform the processing in accordance with the content of the processing.

The storing-reading unit 49 is an example of the storing control unit and is implemented by instructions from the CPU 401 illustrated in FIG. 2, as well as the HD 404, a media I/F 411, and a DVD-RW drive 412 illustrated in FIG. 2. The storing-reading unit 49 stores various data in or retrieves various data from the storage unit 4000, a recording medium 411a, or a DVD-RW 412a. The storage unit 4000, the recording medium 411a, and the DVD-RW 412a are examples of storage units.

In the storage unit 4000, a three-dimensional image information management database (DB) 4001, a model shape management DB 4002, a caption model 4003, a tacit knowledge model 4004, a large-scale language model 4005, and a captured image information management DB 4006 are built.

The three-dimensional image information management DB 4001 manages three-dimensional image information of an item placed in a property. The three-dimensional image information is information that visually represents an item (also referred to as a model) placed in a property. The model shape management DB 4002 manages three-dimensional model shape information of an item placed in a property. The image management server 40 generates three-dimensional image information on a property based on three-dimensional model shape information. The three-dimensional model shape information is information for drawing an item in three dimensions, such as a three-dimensional model of the item or a three-dimensional point group of the item. The three-dimensional model shape information may be represented by data formats such as polygonal data or Computer-Aided Design (CAD) data. The three-dimensional image information management DB 4001 or the model shape management DB 4002 may store a wide-field image, such as an omnidirectional image of a property.

The caption model 4003 is generated by executing a learning process using a combination of an image and a caption comment as learning data and causes a computer to output a caption comment based on the image. The caption comments are explicit knowledge and used as expressions representing tacit knowledge. The caption comment is represented by text data and is a comment for explaining an image among audio or text comments. A caption comment on a property or an item is associated with the identification information of the property or the item.

The tacit knowledge model 4004 is generated by executing a learning process using, as learning data, the correspondence between a combination of three-dimensional image information and a captured image and tacit knowledge (e.g., input information, audio transcript) related to the combination of the three-dimensional image information and the captured image. The tacit knowledge model 4004 causes a computer to output a tacit knowledge-based comment based on an image. The tacit knowledge model 4004 learns on the correspondences between:
—the combination of three-dimensional image information and a captured image, and input information; —the combination of three-dimensional image information and a captured image, and an audio transcript; and —the combination of three-dimensional image information and a captured image, and the combination of an audio transcript and input information. The tacit knowledge-based comment is represented by text data and is a comment other than a caption comment among audio or text comments. In other words, the tacit knowledge-based comment is a comment relating to content that has not appeared in the image.

The large-scale language model 4005 is a computer language model that is generated by executing a learning process using a huge amount of unlabeled text as learning data and is developed on an artificial neural network having a large number of parameters. Sufficient training through methods for learning contexts, such as next sentence prediction and masked language modeling, enables the large-scale language model 4005 to capture many of syntax and meanings of human words. In next sentence prediction, the context is understood, for example, by determining whether a first sentence and a second sentence are consecutive. In masked language modeling, the context is understood by masking a word in a sentence and predicting the masked word from the words preceding and subsequent thereto.

The captured image information management DB 4006 manages in chronological order, wide-field images captured during, for example, meetings regarding a property by the image capturing device 5. This wide-field image may be a moving image (video). Additionally, when the user of a communication terminal, which is described later, performs a capturing operation, the captured image is stored. Capture refers to storing a predetermined-area image representing a predetermined area of a wide-field image as a still image. The captured image information management DB 4006 manages an audio transcript obtained from the image management server 40. This audio transcript is text data converted from voice data recorded by the image capturing device 5 or the communication terminal during a meeting.

### Three-Dimensional Image Information Management Table

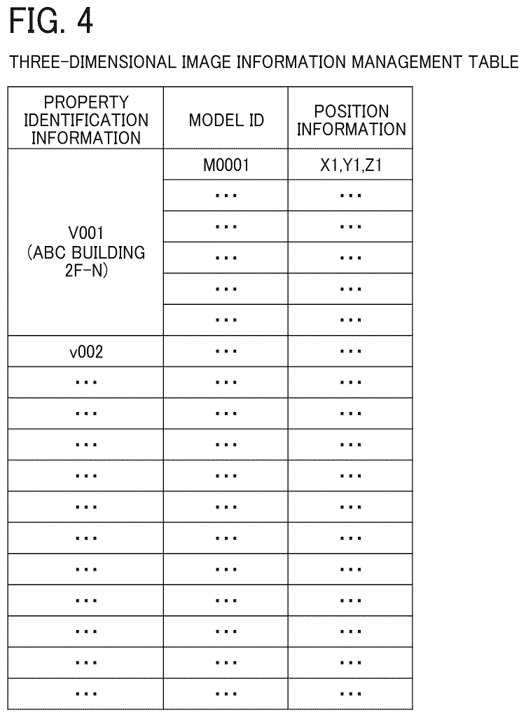

FIG. 4 is a conceptual diagram of a three-dimensional image information management table. The storage unit 4000 stores the three-dimensional image information management DB 4001 that is implemented in the form of an image information management table as illustrated in FIG. 4. In the image information management table in FIG. 4, model ID and position information are stored in association with property identification information.

The property identification information is an example of information for identifying a property. The term “property” refers to any space in which an item can be placed, such as a facility or a room in a facility. The types of items placed within a facility vary depending on the function of the facility. The property may be represented in units that are easy to manage, such as “ABC Building 2F-N (North side of the second floor)”.

The model ID is an example of model identification information for identifying an item placed in a property. The item may be represented as three-dimensional model shape information such as polygonal data or computer-aided design (CAD) data, stored in the model shape management DB 4002. The three-dimensional image information is associated with the three-dimensional model shape stored in the model shape management DB 4002 by the model ID.

The position information is information indicating the position of the model of an item in a three-dimensional virtual space representing a property, by three-dimensional coordinates of XYZ. The position information is indicated by, for example, the three-dimensional coordinates of eight points defining a rectangular parallelepiped space occupied by the model.

This position information is obtained as the positional information (latitude, longitude, and altitude) of the relay device 3, by a global navigation satellite system (GNSS) satellite such as a global positioning system (GPS) satellite or using an indoor MEssaging system (IMES) as an indoor GPS. Indoor positioning may be performed using various methods, such as Wi-Fi positioning, radio frequency identifier (RFID) positioning, beacon-based positioning, pedestrian dead reckoning, geomagnetic positioning, acoustic positioning, and ultra wide band (UWB) positioning.

As described above, the position information in FIG. 4 is stored in association with the absolute position on the earth. For example, by associating the origin (X=0, Y=0, Z=0) of the position information in FIG. 4 with the absolute position (latitudes, longitudes, altitudes) on the earth, all coordinates in the three-dimensional image including the three-dimensional model and components, are associated with the absolute position on the earth. That is, the three-dimensional image and the captured image are aligned.

### Captured Image Information Management Table

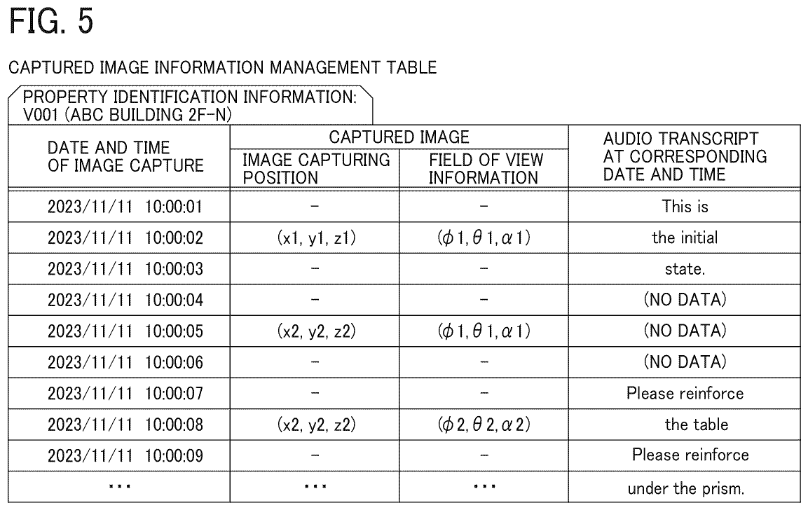

FIG. 5 is a conceptual diagram of a captured image information management table. The storage unit 4000 stores the captured image information management DB 4006 that is implemented in the form of a captured image information management table as illustrated in FIG. 5. In the captured image information management table illustrated in FIG. 5, the date and time of image capture, the wide-field image, the captured image, the image capturing position, the field of view information, and the audio transcript at the corresponding date and time are stored in association with property identification information as data items to be managed.

The position of the image capturing device 5 is determined by the GNSS of the relay device 3 to which the image capturing device 5 is attached.

The image capturing date and time indicate the date and time information when the captured image is recorded by the image capturing device 5. One or more captured images are stored in association with the image capturing date and time.

The image capturing position indicates the position (absolute position on the earth) of the image capturing device 5 at the time the captured image was captured. The captured image is one that was directly stored by the image management server 40.

The field-of-view information is information for identifying a predetermined area that indicates a predetermined-area image displayed on a communication terminal (a terminal for viewing real-time wide-angle view images during a meeting, as described later).

The audio transcript registered in the “audio transcript at the corresponding date and time” field is the audio transcript generated by voice recognition performed on the audio collected by the image capturing device 5. The audio transcript at the corresponding date and time is the audio transcript transmitted from the meeting management server 20.

### Functional Configuration of Meeting Management Server

Referring back to FIG. 3, the functional configuration of the meeting management server 20 is described below. The meeting management server 20 includes a transmission-reception unit 21, a screen generation unit 22, and a storing-reading unit 29. These functional units are functions or means of functioning that are implemented by the operation of one or more hardware components illustrated in FIG. 2 in response to instructions from the CPU 401, based on a program loaded from the HD 404 to the RAM 403. The meeting management server 20 further includes a storage unit 2000 implemented by the HD 404 in FIG. 2. The storage unit 2000 is an example of a memory (storage means).

In FIG. 3, all the functions are implemented on the single meeting management server 20. Alternatively, the meeting management server 20 may be configured such that the functions are distributed across multiple computers.

The transmission-reception unit 21, which is an example of a transmission unit or a reception unit, is implemented by instructions from the CPU 401 illustrated in FIG. 2 and the communication I/F 407 illustrated in FIG. 2. The transmission-reception unit 41 transmits and receives various data (or information) to and from another terminal, device, apparatus, or system via the communication network N.

The screen generation unit 22, which is an example of a screen generation unit, is implemented by instructions from the CPU 401 illustrated in FIG. 2. The screen generation unit 42 generates various screens. In a case where the terminal device 10 executes a web application, the screen information is generated in a format of, for example, HTML, XML, CSS, or JAVASCRIPT. For this reason, the screen information may be referred to as a web application. In a case where the terminal device 10 executes a client application, the screen information is held by the terminal device 10, and the screen information representing the screen to be displayed is transmitted in a format of, for example, XML.

The storing-reading unit 29 is an example of the storing control unit and is implemented by instructions from the CPU 401 illustrated in FIG. 2, as well as the HD 404, a media I/F 411, and a DVD-RW drive 412 illustrated in FIG. 2. The storing-reading unit 49 stores various data in or retrieves various data from the storage unit 2000, a recording medium 411a, or a DVD-RW 412a. The storage unit 2000, the recording medium 411a, and the DVD-RW 412a are examples of storage units.

### Meeting Information Management Table

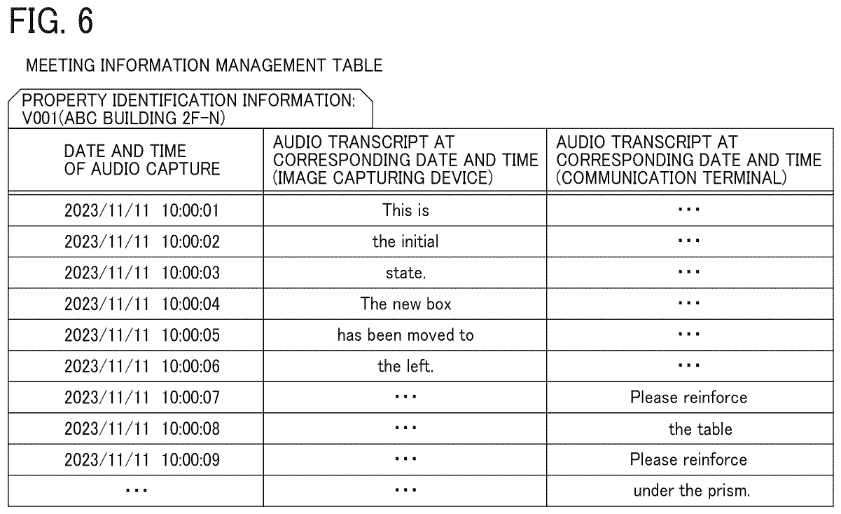

FIG. 6 is a conceptual diagram of a meeting information management table. The storage unit 2000 stores a meeting information management DB 2001 that is implemented in the form of a meeting information management table as illustrated in FIG. 6.

In the meeting information management table, the date and time of audio capture, audio transcript at the corresponding date and time (image capturing device), and audio transcript at the corresponding date and time (communication terminal) are stored in association with property identification information as data items to be managed.

The date and time of audio capture indicates the date and time of capturing audio by the image capturing device 5 or the communication terminal 9.

The audio transcript registered in the “audio transcript at the corresponding date and time (image capturing device)” field is an audio transcript generated based on the audio captured by the image capturing device 5. The audio transcript is comment data regarding an item that a participant of the meeting spoke about while viewing a live image.

The audio transcript registered in the “audio transcript at the corresponding date and time (communication terminal)” field is an audio transcript generated based on the audio that is the speech uttered by a participant viewing a live image on the communication terminal. The audio transcript is comment data regarding an item that a participant of the meeting spoke about while viewing a live image.

### Transmission of Wide-Field Images and Audio Data

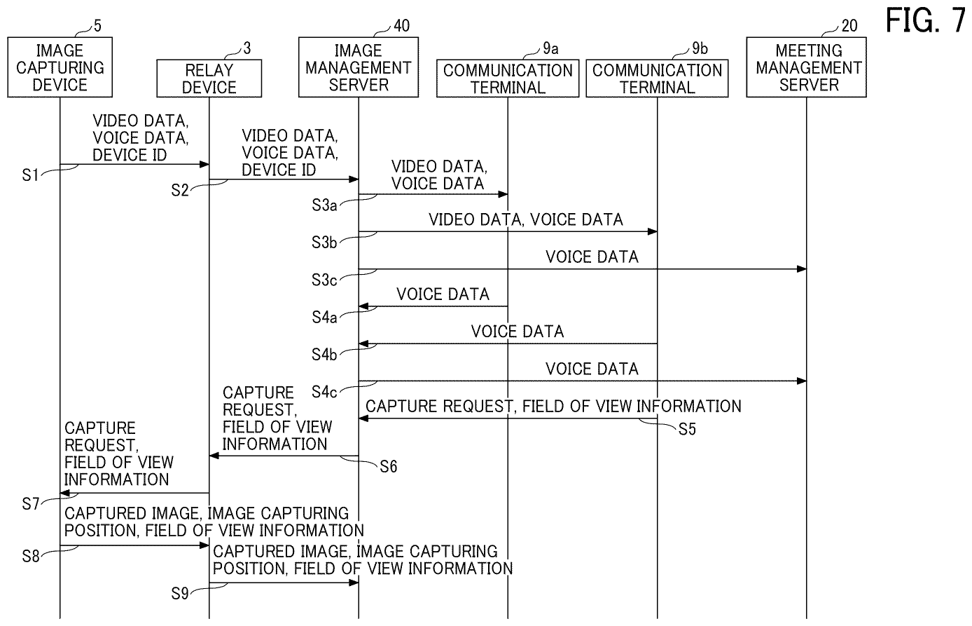

FIG. 7 is a sequence diagram illustrating a process of communicating wide-field images and audio data. In the following description, the image capturing device 5, a communication terminal 9a used by a participant A, and a communication terminal 9b used by a participant B are participating in the same remote communication. Steps S1 through S4 in FIG. 7 are performed repeatedly.

In step S1, the image capturing device 5 captures an image of the surroundings and collects audio to transmit video data (wide-field image) and audio data to the relay device 3. The image capturing device 5 also transmits a device ID for identifying the image capturing device 5 to identify the property. As a result, the relay device 3 acquires the video data and the audio data. The image management server 40 has device IDs pre-associated with properties.

In step S2, the relay device 3 transmits the acquired video data, audio data, and device ID to the image management server 40 via the communication network N. Accordingly, the transmission-reception unit 41 of the image management server 40 receives the video data, audio data, and device ID. The captured image management server 40 identifies a property by the device ID. As a result, the wide-field image and the image capturing date and time are stored by the storing-reading unit 49 in the image information management DB 4006, for example, every second. The live images may be streamed without being stored.

In step S3a, the image management server 40 reads participant IDs that are participating in the same meeting as the image capturing device 5 from, for example, the meeting information. The image management server 40 further reads the IP addresses of the communication terminals 9a and 9b based on the read participant IDs. The captured image management server 40 refers to the IP address of the communication terminal 9a and transmits the received video data and audio data to the communication terminal 9a. As a result, the communication terminal 9a receives the video data and the audio data, displays the wide-field image, and outputs the sound.

In step S3b, in a similar manner, the image management server 40 refers to the IP address of the communication terminal 9b and transmits the video data and the audio data to the communication terminal 9b. As a result, the communication terminal 9b displays the wide-field image and outputs the sound.

The image management server 40 calls the API of the meeting management server 20 to transmit the audio data to the meeting management server 20. Accordingly, the transmission-reception unit 21 of the meeting management server 20 receives the audio data. The meeting management server 20 (or an existing voice recognition server) generates text data (also referred to as audio transcript) by converting the voice part into text using the audio data. The storing-reading unit 29 stores the audio transcript at the current date and time (image capturing device) in the meeting information management DB 2001.

In steps S4a and 4b, the communication terminals 9a and 9b transmit the voice data of participants A and B to the meeting management server 20. This audio data is generated by the microphone capturing the voice of participants A and B operating communication terminals 9a and 9b, respectively, and converting the voice into audio data.

In step S4c, the image management server 40 calls the API of the meeting management server 20 to transmit the audio data to the meeting management server 20. Accordingly, the transmission-reception unit 21 of the meeting management server 20 receives the audio data. The meeting management server 20 (or an existing voice recognition server) generates text data by converting the voice part into text using the audio data. The storing-reading unit 29 stores the audio transcript at the current date and time (communication terminal) in the meeting information management DB 2001.

In step S5, each of the participants A and B of the communication terminals 9a and 9b (participant B in FIG. 6) can change the viewpoint of the video data, which is a wide-field image. When the participant B wants to save a predetermined-area image of the wide-field image displayed by changing the viewpoint, the participant B can perform the capture operation at any desired timing.

When the capture operation is accepted, the communication terminal 9b transmits a capture request and the field of view information indicating the predetermined area currently displayed on the display to the image management server 40.

In step S6, upon receiving the capture request and field of view information, the image management server 40 identifies the IP address of the relay device 3 participating in the same meeting as the communication terminal 9b and transmits the capture request and field of view information.

In step S7, the relay device 3 receives the capture request and field of view information and transfers the capture request and field of view information to the image capturing device 5.

In step S8, when receiving the capture request, the image capturing device 5 generates a captured image based on the field of view information. The image capturing device 5 transmits the captured image, image capturing position, and field of view information to the relay device 3. When the image capturing device 5 is fixed, the image capturing position may be pre-registered in the image management server 40.

In step S9, the relay device 3 transmits the captured image, image capturing position, and field of view information to the image management server 40. The image management server 40 identifies a property by the device ID, similar to step S3. The storing-reading unit 49 stores the captured image, image capturing position, and field of view information in the captured image information management DB 4006.

As a result of the above processing, the captured image information management DB 4006 stores the captured image, image capturing position, and field of view information captured from the wide-field image. The meeting information management DB 2001 stores the audio transcript transmitted by the image capturing device 5 and the communication terminal 9. As described later, the audio transcript of the meeting information management DB 2001 may be transmitted to the captured image information management DB 4006.

### Example of Update of Model and Generation of Text Information

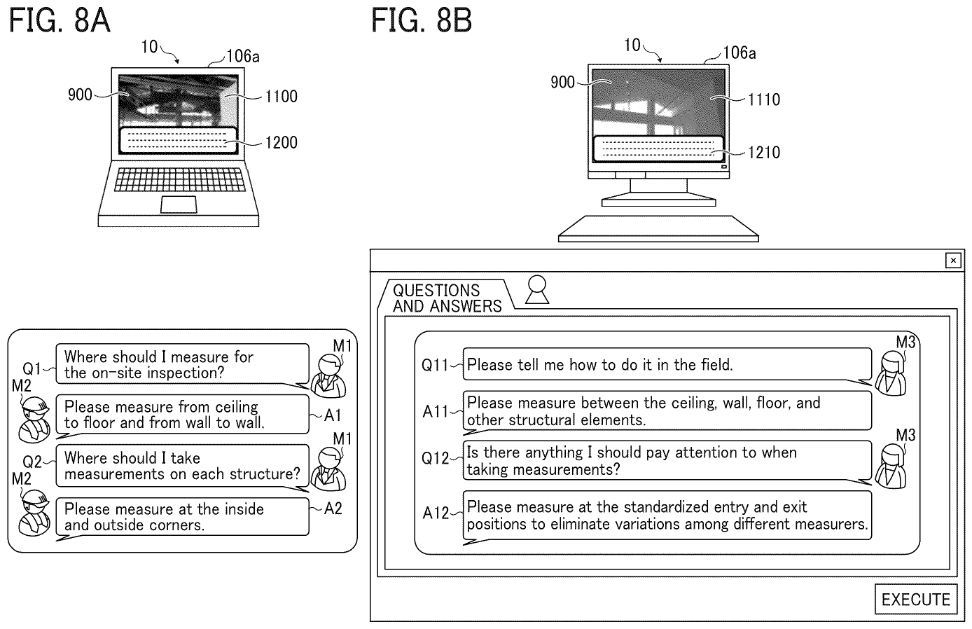

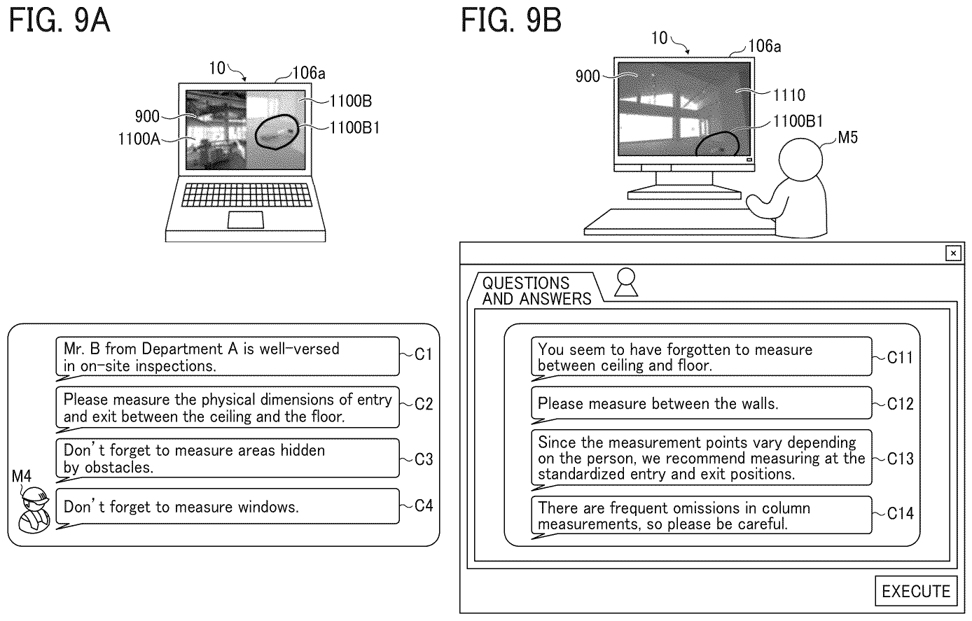

A model update method and a text information generation method are described below with reference to FIGS. 8A to 9B. In FIGS. 8A to 9B, the inspection information is not used for updating the model and generating the text information. However, learning can be similarly performed by replacing or adding, for example, an utterance Q1 in a conversation with the inspection information.

FIGS. 8A and 8B are diagrams illustrating display screens on the terminal device 10 in a model update process and a text information generation process, respectively. FIG. 8A is a diagram illustrating the model updating process. The display control unit 13 of the terminal device 10 causes the display 106a to display a display screen 900 received from the image management server 40. The display screen 900 includes a target image 1100 and text 1200.

The input reception unit 12 of the terminal device 10 receives, via the microphone 109b, audio information indicating a conversation including utterances Q1, A1, Q2, and A2 between a data provider M1 and a data provider M2, as input information input by a data provider on the display screen 900. The data providers M1 and M2 preferably have a wealth of practical knowledge including tacit knowledge. The tacit knowledge model 4004 is updated based on such conversations between data providers including the data providers M1 and M2, allowing the user to obtain useful tacit knowledge-based comments.

The identification unit 44 identifies the target image 1100, which is a portion of the display screen 900 excluding the text 1200.

Then, the determination unit 43 determines the relevance level between the caption comment acquired from the caption model 4003 using the target image 1100 and the conversation including the utterances Q1, A1, Q2, and A2.

The update unit 46 updates the tacit knowledge model 4004 with learning data including the target image 1100 and a tacit knowledge-based comment that is a comment determined to have low relevance among the utterances Q1, A1, Q2, and A2. The update unit 46 updates the caption model 4003 with learning data including the target image 1100 and a caption comment that is a comment determined to have high relevance among the utterances Q1, A1, Q2, and A2.

Thus, the tacit knowledge model 4004 learns the correspondence between the target image 1100 and the utterances Q1, A1, Q2, and A2. Features are extracted from the target image 1100 by some feature extraction models suitable for images, such as a convolutional neural network (CNN). The features represent, for example, what is shown where, or the content of work performed in the image. Thus, the tacit knowledge model 4004 learns the correspondence between the features of the image and the utterances Q1, A1, Q2, and A2.

FIG. 8B is a diagram illustrating the text information generation process.

The display control unit 13 of the terminal device 10 causes the display 106a to display the display screen 900 received from the image management server 40. The display screen 900 includes an image 1110 and text 1210.

The input reception unit 12 of the terminal device 10 receives, via the microphone 109b, audio information indicating questions Q11 and Q12 asked by a user M3, as input information input by a user on the display screen 900.

The identification unit 44 identifies the image 1110 not including the text 1210 as a target image.

The text information generation unit 45 uses the image 1110 and the tacit knowledge model 4004 to obtain a tacit knowledge-based comment. The tacit knowledge model 4004 extracts features from the image 1110, determines that the features of the image 1110 in FIG. 8 are similar to those of the image 1110 at the time of update, and identifies the utterances Q1, A1, Q2, and A2 related to the image 1110. The utterances Q1, A1, Q2, and A2 are tacit knowledge-based comments.

The text information generation unit 45 generates text information on answers A11 and A12 to the questions Q11 and Q12, respectively, based on the large-scale language model 4005, using, for example, the tacit knowledge-based comments (the utterances Q1, A1, Q2, and A2) and the questions Q11 and Q12.

The display control unit 13 of the terminal device 10 causes the display 106a to display the text information on the answers A11 and A12 received from the image management server 40.

FIGS. 9A and 9B are diagrams illustrating display screens on the terminal device 10 in a model update process and a text information generation process, respectively. Model update without using a question sentence and text information generation without using a question senesce are described below with reference to FIG. 9A and FIG. 9B, respectively.

FIG. 9A is a diagram illustrating the model update process. FIG. 9A illustrates an example in which the tacit knowledge model 4004 is updated by not a conversation between data providers but audio information representing utterances of a single data provider and a partial image.

The display control unit 13 of the terminal device 10 causes the display 106a to display the display screen 900 received from the image management server 40. The display screen 900 includes a first image 1100A and a second image 1100B.

The input reception unit 12 of the terminal device 10 receives, via the keyboard 110a, text information indicating comments C1 to C4 by a data provider M4, as input information input by a data provider on the display screen 900.

The input reception unit 12 receives, via the mouse 110b, operation information indicating an operation performed by the data provider M4 to identify a partial image 1100B1 of the second image 1100B, as input information input by the data provider M4 on the display screen 900.

The identification unit 44 may identify the partial image 1100B1 as a target image. Alternatively, the identification unit 44 may identify the first image 1100A or the second image 1100B as a target image.

The determination unit 43 determines the relevance between a caption comment acquired from the caption model 4003 using the target image and the comments C1 to C4.

The update unit 46 updates the tacit knowledge model 4004 with learning data including the partial image 1100B1 and a tacit knowledge-based comment that is a comment determined to have low relevance among the comments C1 to C4, and updates the caption model 4003 with learning data including the partial image 1100B1 and a caption comment that is a comment determined to have high relevance among the comments C1 to C4.

Thus, the tacit knowledge model 4004 learns the correspondence between the partial image 1100B1 and the comments C1 to C4. Features are extracted from the partial image 1100B1 by some feature extraction models suitable for images, such as a CNN. The features represent, for example, which objects (items) appear in which positions and the tasks being performed. Thus, the tacit knowledge model 4004 learns the correspondence between the features of the image and the comments C1 to C4.

FIG. 9B is a diagram illustrating the text information generation process. The display control unit 13 of the terminal device 10 causes the display 106a to display the display screen 900 received from the image management server 40. The display screen 900 includes the image 1110.

A user M5 does not input information to the display screen 900. The input reception unit 12 does not receive information input by a user to the display screen 900. The identification unit 44 identifies the image 1110, which is the entire display screen 900, as a target image.

When the user M5 performs an operation for specifying the partial image 1100B1 in the display screen 900, the input reception unit 12 receives, via the mouse 110b, operation information indicating the operation for specifying the partial image as input information. In this case, the identification unit 44 identifies the partial image in the display screen 900 as a target image according to the operation information.

The text information generation unit 45 uses the partial image 1100B1 and the tacit knowledge model 4004 to obtain a tacit knowledge-based comment. The tacit knowledge model 4004 determines that the features of a partial image 1110B1 in FIG. 9B are similar to those of the partial image 1110B1 at the time of update, and identifies the comments C1 to C4 related to the partial image 1110B1. The tacit knowledge model 4004 extracts the comments C1 to C4 as tacit knowledge-based comments.

The text information generation unit 45 generates text information on comments C11 to C14 based on the large-scale language model 4005, using, for example, the tacit knowledge-based comments. The text information generation unit 45 may generate text information using a preset fixed question when no question sentence is input, instead of using a method that does not use any question.

The display control unit 13 of the terminal device 10 causes the display 106a to display the text information on the comments C11 to C14 received from the image management server 40.

### Operations or Processes

As an example of a process based on an audio transcript and one of a captured image and three-dimensional image information, a method for displaying the audio transcript and the one of the captured image and the three-dimensional image information on a single screen is described below. In other words, the tacit knowledge model 4004 is not used.

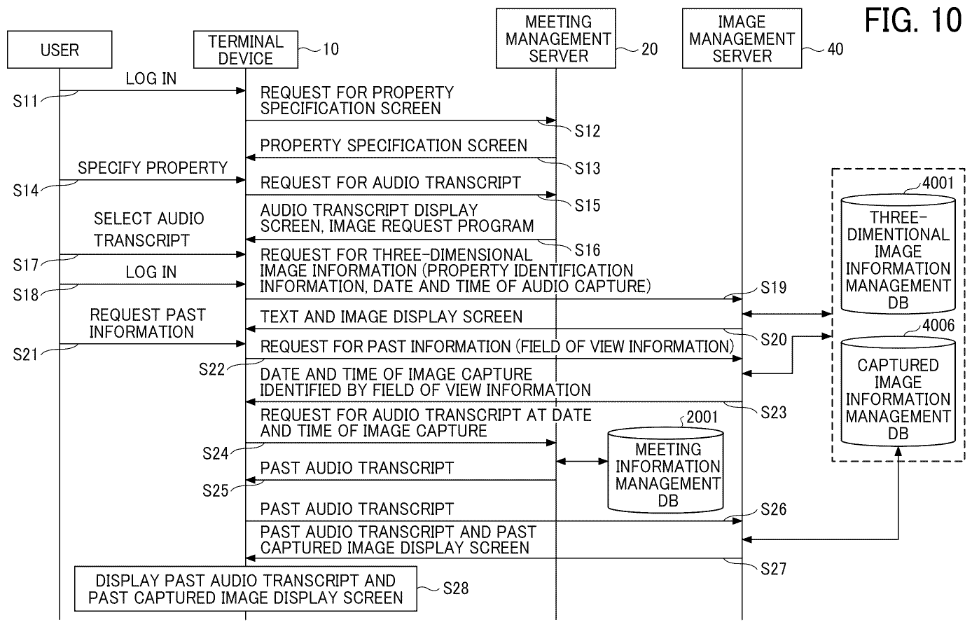

FIG. 10 is a sequence diagram illustrating a process of generating screen information in which an audio transcript and one of a captured image and three-dimensional image information are arranged, as the process based on the audio transcript and the one of the captured image and the three-dimensional image information.

In step S11, the user performs a login operation on the terminal device 10. This login is a login to the meeting management server 20. The input reception unit 12 of the terminal device 10 receives the login operation. The login method may be any existing method. It is assumed that the login is successful.

The user logs in to the meeting management server 20 and then logs in to the image management server 40. Alternatively, the user may log in to the image management server 40 first and then log in to the meeting management server 20.

In step S12, in response to the successful login, the transmission-reception unit 11 of the terminal device 10 transmits a request for a property specification screen 200 to the meeting management server 20.

In step S13, the transmission-reception unit 21 of the meeting management server 20 receives the request for the property specification screen 200.

The screen generation unit 22 generates the property specification screen 200, and the transmission-reception unit 21 transmits the screen information of the property specification screen 200 to the terminal device 10.

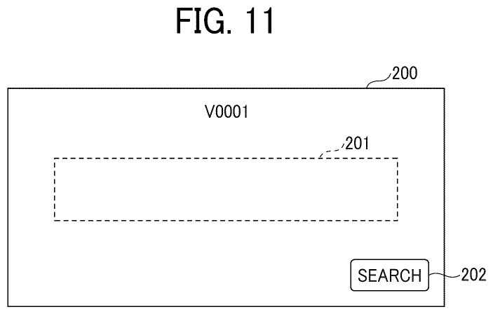

In step S14, the transmission-reception unit 11 of the terminal device 10 receives the screen information of the property specification screen 200. The display control unit 13 causes the property specification screen 200 to be displayed as illustrated in FIG. 11. The user inputs property identification information (for example, V0001, ABC BUILDING, 2F-N) on the displayed property specification screen 200. The input reception unit 12 of the terminal device 10 receives the property identification information.

In step S15, the transmission-reception unit 11 of the terminal device 10 specifies the property identification information and transmits a request for an audio transcript to the meeting management server 20.

The transmission-reception unit 21 of the meeting management server 20 receives the request for an audio transcript, and the storing-reading unit 29 searches the meeting information management DB 2001 using the property identification information as a search key. The screen generation unit 22 of the meeting management server 20 generates an audio transcript display screen 210 displaying an audio transcript, and the transmission-reception unit 21 transmits the screen information of the audio transcript display screen 210 to the terminal device 10.

The transmission-reception unit 21 transmits an image request program to the terminal device 10 to allow the terminal device 10 to obtain the three-dimensional image information in response to a request for an audio transcript. The image request program is, for example, a web application. The web application is installed in the meeting management server 20 with the authorization of the administrator of the meeting management server 20 acquired by the administrator of the image management server 40. Alternatively, a Uniform Resource Locator (URL) with the image request program may be transmitted to the terminal device 10. Since the web application is used to acquire three-dimensional image information from the image management server 40, the web application has the function of connecting the terminal device 10 to the image management server 40 and requesting or displaying three-dimensional image information.

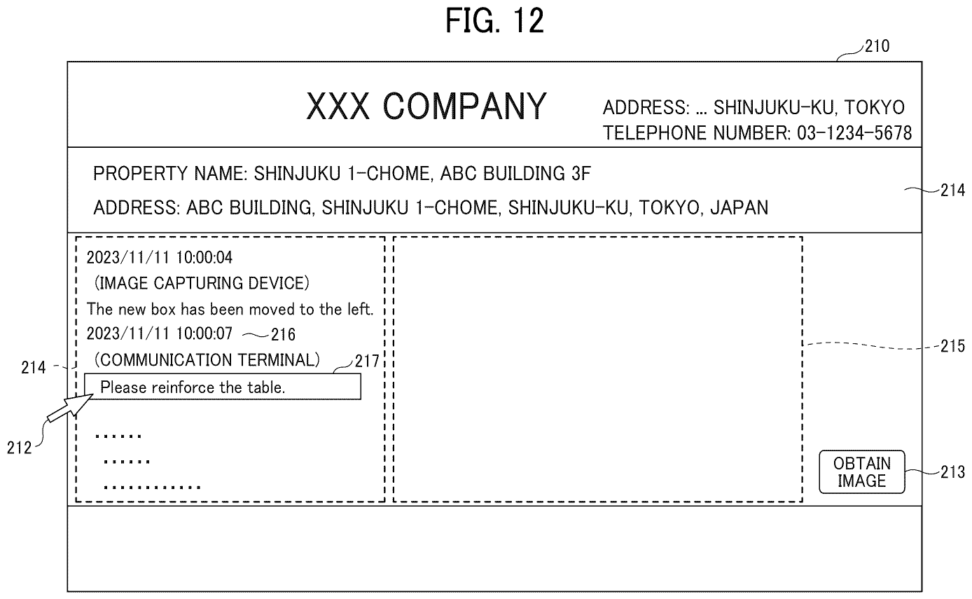

The transmission-reception unit 11 of the terminal device 10 receives the screen information of the audio transcript display screen 210 and the image request program. The display control unit 13 causes the audio transcript display screen 210 to be displayed as illustrated in FIG. 12. Thus, the audio transcript related to the property is displayed. The user selects any audio transcript on the displayed audio transcript display screen 210. The user can select the audio transcript based on an item name included in the audio transcript. Selecting the audio transcript is to display the three-dimensional image information and captured image identified by the audio transcript. Selecting the audio transcript also identifies the date and time of audio capture. The input reception unit 12 of the terminal device 10 receives an operation for selecting the audio transcript.

The user performs an operation to request the three-dimensional image information of the property and the captured image by pressing an image acquisition button 213 while the audio transcript is selected. By simply selecting the audio transcript, the user can request the corresponding three-dimensional image data and the captured image. The input reception unit 12 of the terminal device 10 receives the operation for requesting the three-dimensional image information of the property and the captured image. The three-dimensional image information of the property represents the three-dimensional image information of an item placed in a virtual space representing the property. The item is represented using 3D model shape information.

The audio transcript display screen 210 includes a first display area 214 for displaying the audio transcript acquired from the meeting management server 20 and a second display area 215 for displaying the three-dimensional image information of the item and the captured images acquired from the image management server 40. In step S17, the audio transcript is displayed in the first display area 214, whereas nothing is displayed in the second display area 215.

In step S18, when the user is not logged in to the image management server 40, the user inputs a login operation to the terminal device 10. This login operation is performed on the image management server 40. The input reception unit 12 of the terminal device 10 receives the login operation. The login method may be any existing method. It is assumed that the login is successful. The login operation of the user may be omitted by using, for example, single sign-on.

In step S19, the terminal device 10 executes the image request program to request the three-dimensional image information. Accordingly, the transmission-reception unit 11 specifies the property identification information of the property and the date and time of audio capture that are selected by the user and transmits a request for the three-dimensional image information of the property and the captured image to the image management server 40. Since the captured image is obtained in association with the three-dimensional image information, the term of “captured image” is omitted in FIG. 10. The transmission-reception unit 11 may transmit the URL of the meeting management server 20 to the image management server 40 so that the terminal device 10 can redirect to the meeting management server 20. The three-dimensional image information of the property is an image of an item placed in the virtual space representing the property.

Since the item is represented using the 3D model shape information, the terminal device 10 projects the three-dimensional model shape of the item onto a two-dimensional plane to generate a planar image. The user can browse an item while changing the viewpoint. The transmission-reception unit 11 may transmit the meeting information acquired from the meeting management server 20 to the image management server 40. The image request program receives meeting information from the web application connected to the meeting management server 20 as, for example, a URL parameter.

In step S20, the transmission-reception unit 41 of the image management server 40 receives the request for the three-dimensional image information of the property and the captured image. The storing-reading unit 49 searches the three-dimensional image information management DB 4001 using the property identification information and acquires the three-dimensional image information of each item. The storing-reading unit 49 searches the captured image information management DB 4006 using the property identification information and acquires the captured images (an example of a two-dimensional image), position information, and field of view information associated with the date and time of image capture that is the closest to the date and time of audio capture. The processing unit 47 requests the screen generation unit 42 to generate a screen including the three-dimensional image information of the property and the captured image. The screen generation unit 42 generates the three-dimensional image information by placing a virtual camera at the position of the position information and determining a field of view of the virtual camera based on the field of view information. The screen generation unit 42 generates a screen corresponding to the second display area 215 in which the three-dimensional image information and the captured image of each item are arranged.

The transmission-reception unit 41 transmits the screen information of the screen corresponding to the second display area 215 to the terminal device 10. The three-dimensional image information of each item included in the screen information is image information of each item that is placed in the property, and the user can change the viewpoint as desired. In other words, all items within the property has corresponding three-dimensional image information in the screen information.

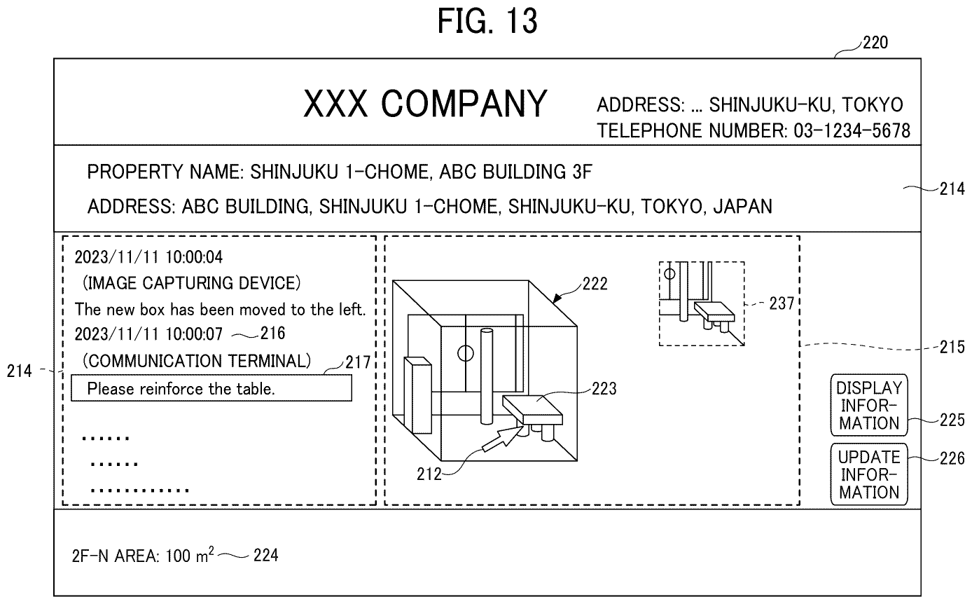

In step S21, the transmission-reception unit 11 of the terminal device 10 receives the screen information of the screen corresponding to the second display area 215, and the display control unit 13 causes a text and image display screen 220 including the first display area 214 and the second display area 215 to be displayed as illustrated in FIG. 13. In step S11, the three-dimensional image information of each item and the captured image are displayed in the second display area 215. The audio transcript is displayed in the first display area 214. Accordingly, the audio transcript corresponding to the identified date and time of audio capture, the captured image at a date and time closest to the date and time of audio capture are displayed on a single screen along with the three-dimensional image information.

The user can change the viewpoint of the three-dimensional image information or zoom in on an item. The user performs an operation for requesting past information. The past information refers to a captured images that is captured earlier than the captured image displayed in step S21 (referred to as a past captured image) and an audio transcript that is captured earlier than the selected audio transcript. The operation for requesting past information can be performed, for example, by pressing an information display button 225. The input reception unit 12 of the terminal device 10 receives the operation for requesting past information. An exact past date and time may be identified by the user. In this embodiment, while past information is being requested, the user may also request future information beyond the audio transcript selected in step S17.

In step S22, when the user presses the information display button 225, the transmission-reception unit 11 of the terminal device 10 requests past information from the image management server 40, specifying the field of view information. This field of view information indicates a field of view specified by the user for the three-dimensional image information. Accordingly, the past information is requested. Additionally, the coordinates pressed by the user with the mouse pointer or the model ID of the item identified by the coordinates are transmitted to the image management server 40.

In step S23, after the transmission-reception unit 41 of the image management server 40 receives the request for past information, the storing-reading unit 49 identifies field of view information that is closest to the received field of view information from the past field of view information of the captured image information management DB 4006. The past filed of view information is information obtained earlier than the date and time of audio capture received in step S19. The storing-reading unit 49 acquires the date and time of image capture associated with the identified field of view information. An exact match for the received field of view information may not always be found in the captured image information management DB 4006. For this reason, the storing-reading unit 49 identifies field of view information that has only a slight difference within a certain range from the captured image information management DB 4006. In addition, the extent to which the search goes back in time may be preset. The storing-reading unit 49 identifies the most recent image information when multiple pieces of field of view information meet the criteria. The acceptable range of variation and the time range can be configured by the user.

In addition, the storing-reading unit 49 retrieves the captured image associated with the date and time of image capture from the captured image information management DB 4006. This captured image is referred to as a past captured image in the following description.

The transmission-reception unit 41 of the image management server 40 transmits the date and time of image capture identified by the field of view information to the terminal device 10.

In step S24, the transmission-reception unit 11 of the terminal device 10 receives the date and time identified by the field of view information. For example, the image management server 40 notifies the terminal device 10 of the URL of the meeting management server 20 and redirects the terminal device 10. Accordingly, the transmission-reception unit 11 of the terminal device 10 identifies the date and time of image capture identified by the field of view information and transmits a request for an audio transcript to the meeting management server 20.

In step S25, the transmission-reception unit 21 of the meeting management server 20 receives the request for an audio transcript, and the storing-reading unit 29 searches the meeting information management DB 2001 for the date and time of audio capture using the received date and time of image capture. The storing-reading unit 29 retrieves the audio transcript at the corresponding date and time (imaging capturing device) associated with the same or closest date and time of image capture and the audio transcript at the corresponding date and time (communication terminal) associated with the same or closest date and time of audio capture from the meeting information management DB 2001. The audio transcripts described below are referred to as past audio transcript. The transmission-reception unit 21 transmits the acquired past audio transcript to the terminal device 10.

In step S26, upon receiving the past audio transcript, the transmission-reception unit 11 of the terminal device 10 transmits the past audio transcript to the image management server 40. The transmission-reception unit 41 of the image management server 40 receives the past audio transcript as a response to the request in step S23. The storing-reading unit 49 stores the past audio transcript in the captured image information management DB 4006 in association with the date and time of image capture identified in step S23. As a result, the captured image is associated with the audio transcript.

In step S27, upon receiving the past audio transcript, the processing unit 47 associates the captured image that has been displayed in step S20, the three-dimensional image information corresponding to the field of view information received in step S22, the past captured image identified in step S23, and the past audio transcript, and requests the screen generation unit 42 to generate screen information to display these items of information. The screen generation unit 42 generates the three-dimensional image information by determining a field of view of the virtual camera based on the field of view information from step S22. The screen generation unit 42 generates a screen corresponding to the second display area 215 in which the generated three-dimensional image information, the captured image from step S20, the past captured image, and the past audio transcript are displayed in association with each other. The transmission-reception unit 41 transmits the screen information of the screen corresponding to the second display area 215 to the terminal device 10.

In step S28, the transmission-reception unit 11 of the terminal device 10 receives the image information of the screen information representing the screen corresponding to the second display area 215, and the display control unit 13 causes a past audio transcript and past captured image display screen 230 including the first display area 214 and the second display area 215 to be displayed as illustrated in FIG. 14. In step S28, the audio transcript is displayed in the first display area 214, similar to step S11, while the three-dimensional image information of the item, the captured image displayed in step S20, the past captured image, and the past audio transcript are displayed in association with each other in the second display area 215.

### Examples of Screens

FIG. 11 is a diagram illustrating an example of the property specification screen 200 for inputting property identification information. The property specification screen 200 includes a property identification information input field 201 and a search button 202. When the user inputs property identification information in the property identification information input field 201 and presses the search button 202, a list of room numbers is displayed on the audio transcript display screen 210.

FIG. 12 is a diagram illustrating an example of the audio transcript display screen 210. The audio transcript display screen 210 includes a first display area 214 for displaying an audio transcript acquired from the meeting management server 20 and a second display area 215 for displaying image information of an item acquired from the image management server 40. The first display area 214 is defined as the area of the screen other than the second display area 215. The first display area 214 includes an audio transcript obtained from a meeting of the property identified by the property identification information.

The user selects, with a mouse cursor 212, an audio transcript 217 related to an item whose captured image is to be displayed. Selecting the audio transcript also identifies the date and time of audio capture 216. When the user presses the image acquisition button 213, the text and image display screen 220 is displayed.

The second display area 215, which is the area of the screen other than the first display area 214, may be displayed by a program, such as iframe, on a web application.

FIG. 13 is a diagram illustrating an example of the text and image display screen 220. The text and image display screen 220 includes the first display area 214 and the second display area 215 and includes an audio transcript, a captured image, and three-dimensional image information together. The first display area 214 is substantially the same as that in FIG. 214.

In the second display area 215 of the text and image display screen 220, a captured image 237 and three-dimensional image information 222 are displayed. The captured image 237 is a captured image closest in date and time to the date and time of audio capture 216 associated with the selected audio transcript 217 (held by the image management server 40). The three-dimensional image information 222 is, in its initial state, at the same image capturing position and with the same field of view as the captured image 237. However, since the three-dimensional image information 222 is a wide-field image, the user can change the field of view information.

Additionally, when the user wants to view a past captured image of any desired item, the user specifies a field of view to display the item (viewpoint) by performing an operation on the three-dimensional image information 222. For example, the user specifies a field of view to enlarge a table. Then, when the user presses the information display button 225, the past audio transcript and past captured image display screen 230 is displayed. The information display button 225 is used for displaying a past audio transcript (past text) and a past captured image, in addition to displaying text information generated based on a tacit knowledge-based comment as described later. When the user presses the information update button 226, the tacit knowledge model 4004 is updated.

In FIG. 13, a size (floor area) 224 is displayed as information on the property.

The size (floor area) 224 may be a measured value or may be included in the three-dimensional image information management table.

FIG. 14 is a diagram illustrating an example of the past audio transcript and past captured image display screen 230. The past audio transcript and past captured image display screen 230 includes the first display area 214 and the second display area 215. The audio transcript is displayed in the first display area 214.

In FIG. 14, three-dimensional image information 223 of the table, which is one of the items, selected by the user is displayed in the second display area 215. The field of view of the three-dimensional image information 223 is a field of view specified by the user to view the table. In other words, the user performs the operation to adjust the field of view so that the table appears in this manner. The second display area 215 also displays a captured image 237, in substantially the same manner as the second display area 215 of the text and image display screen 220 of FIG. 13. The second display area 215 also displays a past captured image 238. The past captured image 238 is the most recent captured image among the past captured images captured before the captured image 237. Multiple past captured images may be displayed in the second display area 215. The past captured image 238 is a captured image with field of view information closest to the field of view information of the three-dimensional image information 223 specified by the user. Accordingly, the field of view of the past captured image is the same or close to the field of view of the three-dimensional image information 223.

As described above, the user can select the audio transcript 217 to identify the date and time of audio capture 216 and display the captured image 237 associated with the date and time of audio capture 216. Further, the user can specify the field of view of the three-dimensional image information 223 to display the past captured image 238 captured before the captured image 237. By the user operation of specifying the field of view to match that of the captured image 237, images of the item captured at different times can be displayed with the same field of view. This allows the user to compare the three-dimensional model of the item with multiple captured images captured at different times from the same field of view.

In the second display area 215 of FIG. 14, either the three-dimensional image information 223 or the past captured image 238 may be displayed. Further, the captured image 237 may not be displayed.

In the second display area 215, the past audio transcript 232 is displayed. An example of the past audio transcript 232 is “This is the initial state.” The past audio transcript 232 is identified based on the date and time of image capture of the past captured image 238. Accordingly, the past audio transcript 232 can be expected to be comment data related to the past captured image 238.

As described above, the terminal device 10 can display the audio transcript, the three-dimensional image information 223, the captured image 237, the past captured image 238, and the past audio transcript 232 on a single screen.

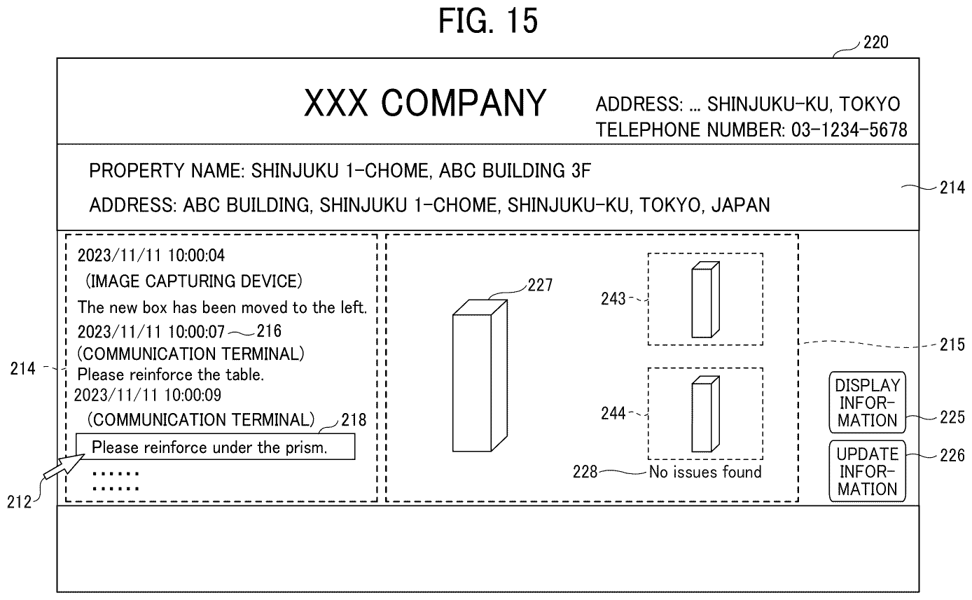

As illustrated in FIG. 15, when the user selects another audio transcript, the information displayed in the second display area 215 also correspond to the selected audio transcript. FIG. 15 is a diagram illustrating the past audio transcript and past captured image display screen 230 when the user selects another audio transcript 218. In FIG. 15, the user selects the audio transcript 218. Accordingly, in the second display area 215, three-dimensional image information 227 of the item, which is a prism, a captured image 243, and a past captured image 244 are displayed. The captured image 243 is identified by the date and time of the audio capture of the audio transcript 218, while the past captured image 244 is identified by the field of view information related to the three-dimensional image information 227. In the second display area 215, a past audio transcript 228 identified by the date and time of image capture of the past captured image 244 is displayed.

As described above, the user can switch the images or text displayed in the second display area 215 by selecting the audio transcript 218.

Obtaining Meeting Information by Image Management Server from Meeting Information Management Server

In FIG. 10, the image management server 40 acquires the past audio transcript obtained by the terminal device 10 from the meeting management server 20. Alternatively, the image management server 40 may directly acquire the past audio transcript from the meeting management server 20.

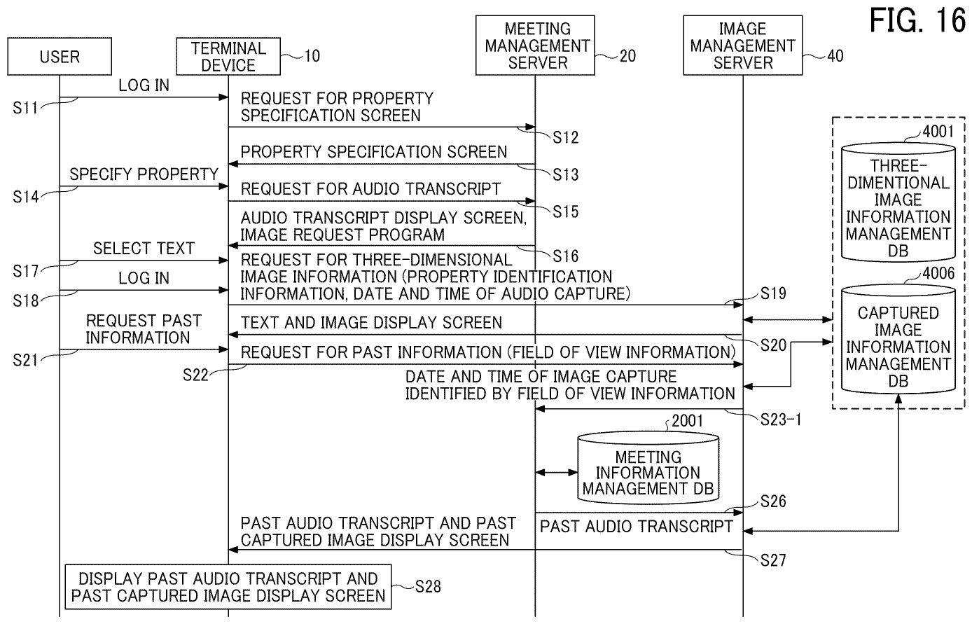

FIG. 16 is a sequence diagram illustrating a process of generating screen information in which an audio transcript and one of a captured image and three-dimensional image information are arranged, as the process based on the audio transcript and the one of the captured image and the three-dimensional image information (modification). The following description with reference to FIG. 16 is focused on the differences from FIG. 10. Steps S11 to S22 may be performed in substantially the same manner as the corresponding steps in FIG. 10.

In step S23-1, the transmission-reception unit 41 of the image management server 40 that has received the request for past information along with the field of view information identifies the date and time of image capture identified by the field of view information and requests the audio transcript corresponding to the date and time of image capture from the meeting management server 20. The content of the processing is substantially the same as step S23 in FIG. 10.

In addition, the storing-reading unit 49 retrieves a past captured image associated with the date and time of image capture.

The transmission-reception unit 21 of the meeting management server 20 receives the request for an audio transcript. The content of the processing is substantially the same as that in FIG. 10. The storing-reading unit 29 of the meeting management server 20 retrieves the audio transcript at the corresponding date and time (image capturing device) and the audio transcript at the corresponding date and time (communication terminal) from the meeting information management DB 2001 based on the received date and time of image capture. The transmission-reception unit 21 transmits the acquired past audio transcript to the image management server 40.

In step S26, the transmission-reception unit 41 of the image management server 40 receives the past audio transcript as a response to the request in step S23.

Subsequent processing may be performed in substantially the same manner as the corresponding steps in FIG. 10. In the process illustrated in FIG. 16, the terminal device 10 can reduce the processing for changing the connection destination, thereby shortening the time required to display the past audio transcript and past captured image display screen 230.

Since the image management server 40 performs a process based on a past audio transcript and at least one of three-dimensional image information and a past captured image, the terminal device 10 can display the past audio transcript and at least one of the three-dimensional image information and the past captured image in the second display area 215. The image management server 40 can perform a process based on the past audio transcript managed by the meeting management server 20 and at least one of the three-dimensional image information and the past captured images managed by the image management server 40, without adding a processing function to the meeting management server 20.

In addition, the meeting management server 20 may perform part of the process based on the past audio transcript and at least one of the three-dimensional image information and the past captured image, and even in this case, the process load on the meeting management server 20 is reduced as compared with a case where the meeting management server 20 performs the entire process based on the past audio transcript and at least one of the three-dimensional image information and the past captured image.

The past audio transcript and at least one of the three-dimensional image information and the past captured image may be displayed in an overlapping or non-overlapping manner.

The first display area 214 and the second display area 215 may be displayed in an overlapping or non-overlapping manner.

Further, each of the first display area 214 and the second display area 215 may be divided into multiple sections, and these sections may be displayed in a mixed arrangement.

### Second Embodiment

In a second embodiment described below, the image management server 40 obtains a tacit knowledge-based comment from a tacit knowledge model using at least one of three-dimensional image information and a captured image and generates text information based on the tacit knowledge-based comment.

In the present embodiment, the hardware configuration illustrated in FIG. 2 and the functional configuration illustrated in FIG. 3 in the above-described embodiment are applicable.

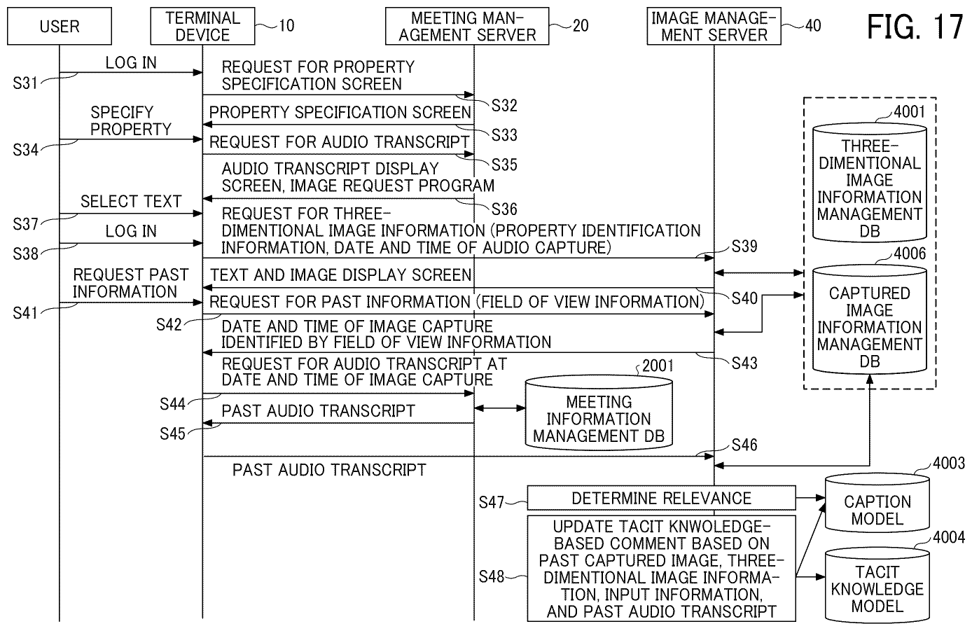

Operations or Processes Learning Phase (Model Update) A model update process in which the tacit knowledge model 4004 learns data will be described with reference to FIG. 17. FIG. 17 is a sequence diagram illustrating a model update process. The following description with reference to FIG. 17 focuses on the differences from FIG. 10. Steps S31 to S40 may be performed in substantially the same manner as steps S11 to S22 in FIG. 10.

In step S41, in addition to the user operation performed in step S21, the user inputs a comment (character information, audio (voice) information) described with reference to FIGS. 8A and 8B and FIGS. 9A and 9B to the terminal device 10. The comment is related to an item. The comment may be referred to as input information. The input information can be a tacit knowledge-based comment. The input information may also include a caption comment describing the item.

In step S42, when the user presses the information update button 226, the transmission-reception unit 11 of the terminal device 10 transmits a request for past information (field of view information, input information) to the image management server 40.

Steps S43 to S46 may be performed in substantially the same manner as steps S23 to S26 in FIG. 10.

In step S47, the transmission-reception unit 41 of the image management server 40 receives the past audio transcript. The determination unit 43 obtains the caption comment identified by the model ID (which is transmitted in step S42) from the caption model 4003, and determines the relevance between the caption comment and the comment included in the input information received in step S42. The determination unit 43 may determine the relevance between the obtained caption comment and the entire comment included in the input information received in step S42, or may divide the comment included in the input information received in step S42 into multiple comments and then determine the relevance between the obtained caption comment and each divided comment.

In step S48, the update unit 46 updates the caption model 4003 by associating the input information determined to have a high relevance in step S47 as a caption comment with the model ID. The update unit 46 updates the tacit knowledge model 4004 with learning data including the input information determined to have low relevance in step S47 and the past audio transcript, as well as the three-dimensional image information (of which the predetermined-area image corresponds to the field of view received in step S42) and the past captured image. In other words, the correspondence between the three-dimensional image information of the item, the past captured image, the past audio transcript, and the input information is learned. Features are extracted from the three-dimensional image information of the item and the past captured image using several feature extraction models suitable for images, such as CNN. The features represent, for example, which objects (items) appear in which positions and the tasks being performed. Thus, the tacit knowledge model 4004 can learn the correspondence between the features of the three-dimensional image information of the item and the past captured image, the audio transcript, and the input information.

The update unit 46 does not need to use the three-dimensional image information of the item or the past captured images for updating the tacit knowledge model 4004.

In the second display area 215 of FIG. 14, either the three-dimensional image information 223 or the past captured image 238 may be displayed. Further, the captured image 237 may not be displayed.

It is not necessary to use both the past audio transcript and the input information, and the tacit knowledge model 4004 can be updated with at least one of the past audio transcript and the input information.

Further, the update unit 46 may also use the audio transcript selected in step S37 and the captured image of the date and time of image capture closest to the date and time of audio capture of the audio transcript, for learning. However, since the date and time of audio capture and the date and time of image capture are not always close to each other, the update unit 46 may use the audio transcript and the captured image for learning only when the difference between the date and time of audio capture and the date and time of image capture is within a predetermined period (range).

In FIG. 17, the image management server 40 obtains the past audio transcript from the terminal device 10. Alternatively, the image management server 40 may obtain the past audio transcript from the meeting management server 20 as illustrated in FIG. 16.

### Screen in Learning Phase

The screens displayed on the terminal device 10 in the learning phase are similar to those in FIGS. 11 to 13. In FIG. 13, the user can input the input information. The information corresponding to the past captured image and the past audio transcript displayed in FIG. 14 is displayed in an inference phase described later.

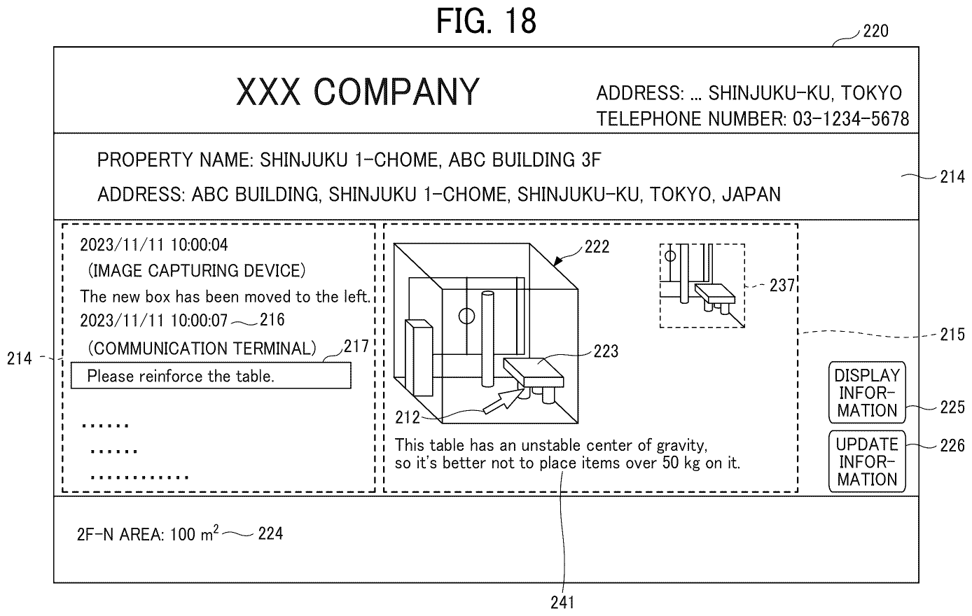

FIG. 18 is a diagram illustrating an example of the text and image display screen 220 displayed on the terminal device 10. The text and image display screen 220 of FIG. 18 includes the first display area 214 and the second display area 215. The size (floor area) 224 is displayed as information on the property in the first display area 214. In the second display area 215 of the captured image 237 and the three-dimensional image information 223 are displayed. In the second display area 215, input information 241 entered by the user stating “This table has an unstable center of gravity, so it is better not to place items over 50 kg on it” are displayed.

The image management server 40 can update the tacit knowledge model 4004 using input information 241. The size (floor area) 224, which is information on the property, can be a caption comment.

### Inference Phase (Generation of Text Information)

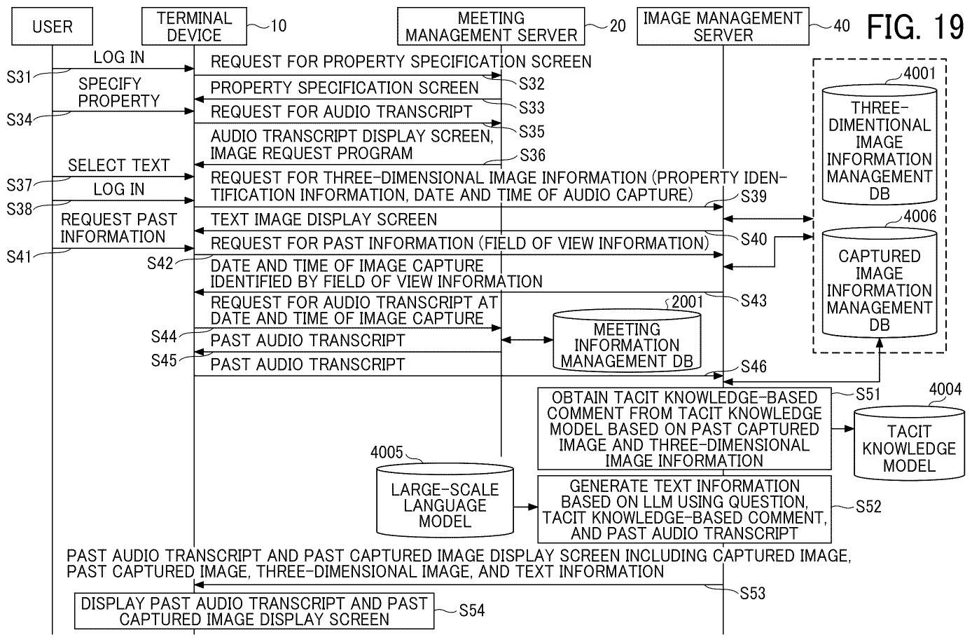

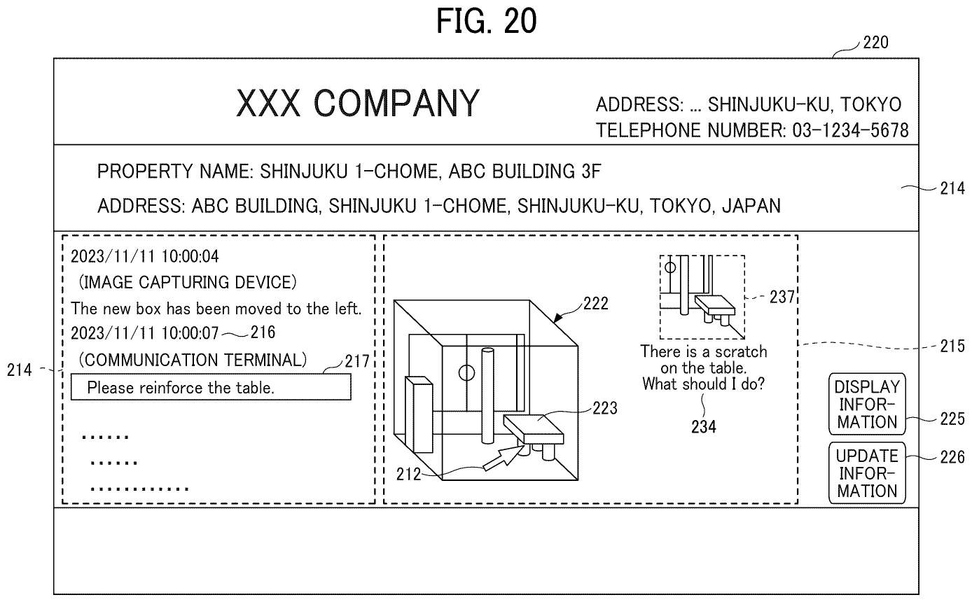

A process of generating text information using the tacit knowledge model 4004 is described below with reference to FIG. 19. FIG. 19 is a sequence diagram illustrating a process of generating text information. The following description with reference to FIG. 19 focuses on the differences from FIG. 10. Steps S31 to S46 may be performed similarly to steps S11 to S26 in FIG. 10. However, in step S41, the user inputs a question sentence related to the item as illustrated in FIG. 20.

In step S51, the transmission-reception unit 41 of the image management server 40 receives the past audio transcript. The processing unit 47 requests the text information generation unit 45 to generate text information. The text information generation unit 45 obtains a tacit knowledge-based comment associated with the three-dimensional image information of the item and the captured image from the tacit knowledge model 4004. The tacit knowledge model 4004 extracts the features of the three-dimensional image information of the item and the past captured image and identifies at least one of a past audio transcript and input information corresponding to the features. The tacit knowledge model 4004 extracts at least the one of the past audio transcript and the input information as a tacit knowledge-based comment.

In step S52, the text information generation unit 45 acquires text information generated by the large-scale language model using the tacit knowledge-based comment, the input information (question sentence), and the past audio transcript. The large-scale language model 4005 is capable of generating more detailed text information using the tacit knowledge-based comment, the input information (question sentence), and the audio transcript. The text information generation unit 45 may convert audio information included in the input information (question sentence) into character information. The text information generated by the text information generation unit 45 may be either audio information or character information.

The text information generation unit 45 may generate the text information without using any past audio transcript or input information (question sentence). The text information generation unit 45 may generate a fixed question in the system and use the fixed question. In this case, the question sentence is not visible to the user. Alternatively, the text information generation unit 45 may generate one or more fixed questions in the system, cause the fixed questions to be displayed on a display to prompt the user to select one of the fixed questions, and use the selected question.

Although the past audio transcript and the input information are not essential as described above, generating text information from the large-scale language model 4005 using the past audio transcript and the input information provides more detailed information on the item. For example, when past audio transcript or the input information includes the degree of damage of the item, text information including an appropriate handling according to the degree of damage can be generated.

In step S53, the processing unit 47 associates the captured image displayed in step S40, the three-dimensional image information corresponding to the field of view received in step S42, the past captured image identified in step S43, and the text information, and requests the screen generation unit 42 to generate screen information to display these items of information. The screen generation unit 42 generates a screen corresponding to the second display area 215 that displays the three-dimensional image information, the captured image, the past captured image, and the generated text information.

The screen generation unit 42 may perform an update process of adding only the text information to the screen corresponding to the second display area 215. The transmission-reception unit 41 of the image management server 40 transmits the screen information of the screen corresponding to the second display area 215 to the terminal device 10. The transmission-reception unit 11 of the terminal device 10 receives the screen information of the screen corresponding to the second display area 215 from the image management server 40.

In step S54, the display control unit 13 of the terminal device 10 causes the past audio transcript and past captured image display screen 230 including the first display area 214 and the second display area 215 to be displayed as illustrated in FIG. 21. Alternatively, the conversion unit 15 may convert the received text information into audio information, and the audio control unit 14 may cause the speaker 109a to reproduce the converted text information. When the received text information is audio information, the text information is reproduced by the speaker 109a, or the conversion unit 15 converts the received text information into character information and displays the converted text information on the display 106a.

In FIG. 19, the image management server 40 obtains the past audio transcript from the terminal device 10. Alternatively, the image management server 40 may obtain the past audio transcript from the meeting management server 20 as illustrated in FIG. 16.

Example of Inference Phase Screen The screens displayed on the terminal device 10 in the inference phase are similar to those in FIGS. 11 to 13. In FIG. 13, the user can input a question sentence.

FIG. 20 is a diagram illustrating an example of the text and image display screen 220 in the inference phase.

The text and image display screen 220 of FIG. 18 includes the first display area 214 and the second display area 215.

FIG. 20 illustrates substantially the same configuration as that of FIG. 13, except that a question sentence is input as input information by the user. In the second display area 215, the three-dimensional image information 222 and the captured image 237 identified by the selected audio transcript 217, and input information 234 (question sentence) are displayed. For example, the input information (question sentences) 234 in FIG. 20 is a message stating “There is a scratch on the table. What should I do?”. Along with the input information 234, the user presses the information display button 225 to request the generation of text information using the tacit knowledge model.

FIG. 21 is a diagram illustrating an example of the past audio transcript and past captured image display screen 230 on which text information is displayed. The past audio transcript and past captured image display screen 230 includes the first display area 214 and the second display area 215. In the second display area 215, the three-dimensional image information 223 of the table, the captured image 237 obtained based on the audio transcript 217, the past captured image 238, and text information are displayed. The text information 235 is a message stating “Since the scratch is less than 1 mm deep, it will be repaired with paint. If it is 1 mm or deeper, it will be polished.” The tacit knowledge model 4004 generates a tacit knowledge-based comment based on the three-dimensional image information 223 of the item, the past captured image 238. The large-scale language model 4005 generates the text information 235 from the tacit knowledge-based comment, past audio transcript, and the input information (question sentence).

For example, when a scratch on the table is detected in the past captured image 238, a tacit knowledge-based comment related to the scratch on the table is extracted. Since the tacit knowledge-based comment, the question related to the scratches, and the past audio transcript regarding the scratches are input to the large-scale language model 4005, appropriate text information corresponding to a scratch on the table can be generated.

The text information 235 is, in a sense, the result of process based on the past audio transcript and one of the three-dimensional image information and the past captured image.

### Third Embodiment

The image management server 40 that generates an image from a captured image and text information is described below.

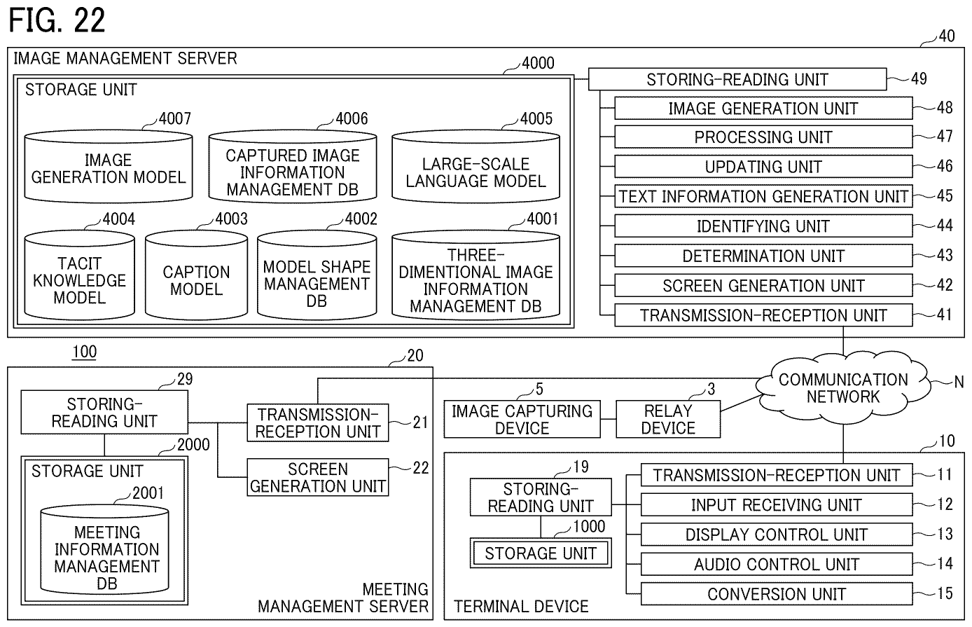

FIG. 22 is a block diagram illustrating functional configurations of the image management server 40, the meeting management server 20, and the terminal device 10 in the information processing system 100.

The following description with reference to FIG. 22 focuses on the differences from FIG. 3.

The image management server 40 illustrated in FIG. 22 further includes an image generation unit 48. The storage unit 4000 of the image management server 40 further stores an image generation model 4007. The other configurations may be the same as those illustrated in FIG. 3.

The image generation unit 48, which is an example of an image generation unit, is implemented by instructions from the CPU 401 illustrated in FIG. 2. The image generation unit 51 inputs either text data or both text data and an image into the image generation model 4007 to generate image information.

The image generation model 4007 is a machine learning model (generative AI) that generates images from text data, or from both text data and images. The image generation model 4007 is trained using, for example, learning data including text data and images. The learning data includes, for example, either text data or both text data and an image for learning as an input or inputs, and an image as a correct answer to an output. For example, learning may be performed so that an image generated by the image generation model 4007, into which either the text data or both the text data and an image included in the learning data are input, gets closer to the image as the correct answer included in the learning data.

### Learning Phase

The processing in the learning phase may be substantially the same as that in FIG. 16. In step S48, the update unit 46 updates the tacit knowledge model 4004 such that the tacit knowledge model 4004 learns a correspondence between inputs, including the comment determined to have low relevance in the step S47 and the past audio transcript, and an output that is the three-dimensional image information of the item or the past captured image. Alternatively, the update unit 46 updates the tacit knowledge model 4004 such that the tacit knowledge model 4004 learns a correspondence between inputs, including the comment, the past audio transcript, and the three-dimensional image information (or the captured image) of the item, and an output that is the past captured image (or the three-dimensional image information).

### Inference Phase (Generation of Text Information)

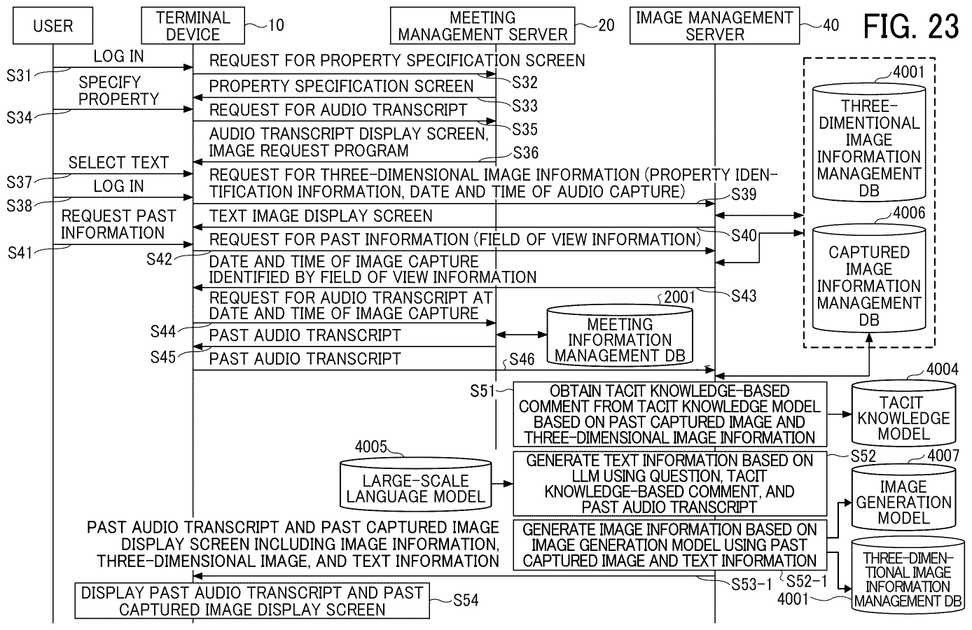

FIG. 23 is a sequence diagram illustrating a process of generating text information and image information. The following description with reference to FIG. 23 focuses on the differences from FIG. 19. In FIG. 23, step S52-1 is added.

In step S52-1, the image generation unit 48 inputs the past captured image and the text information generated by the large-scale language model 4005 to the image generation model 4007 to generate image information. The image generation unit 48 may acquire the image information generated by the image generation model 4007 using the text information generated by the large-scale language model 4005, without using the past captured image.

The storing-reading unit 49 stores (or overwrites) the text information generated by the large-scale language model and the image information generated by the image generation model 4007 in the three-dimensional image information management DB 4001 in association with the past audio transcript stored in the three-dimensional image information management DB 4001 in step S46.

The processing unit 47 associates the three-dimensional image information of the item corresponding to the model identification information, the generated image information, and the text information with each other, and requests the screen generation unit 42 to generate a screen to display the three-dimensional image information of the item, the generated image information, and the text information with each other. The screen generation unit 42 generates a screen corresponding to the second display area 215 that displays the three-dimensional image information of the item, the generated image information, and the text information corresponding to the three-dimensional image information and the captured image of the item. In step 53-1, the transmission-reception unit 41 of the image management server 40 transmits the screen information of the screen corresponding to the second display area 215 to the terminal device 10. The transmission-reception unit 11 of the terminal device 10 receives the screen information of the screen corresponding to the second display area 215 from the image management server 40.

### Example of Inference Phase Screen

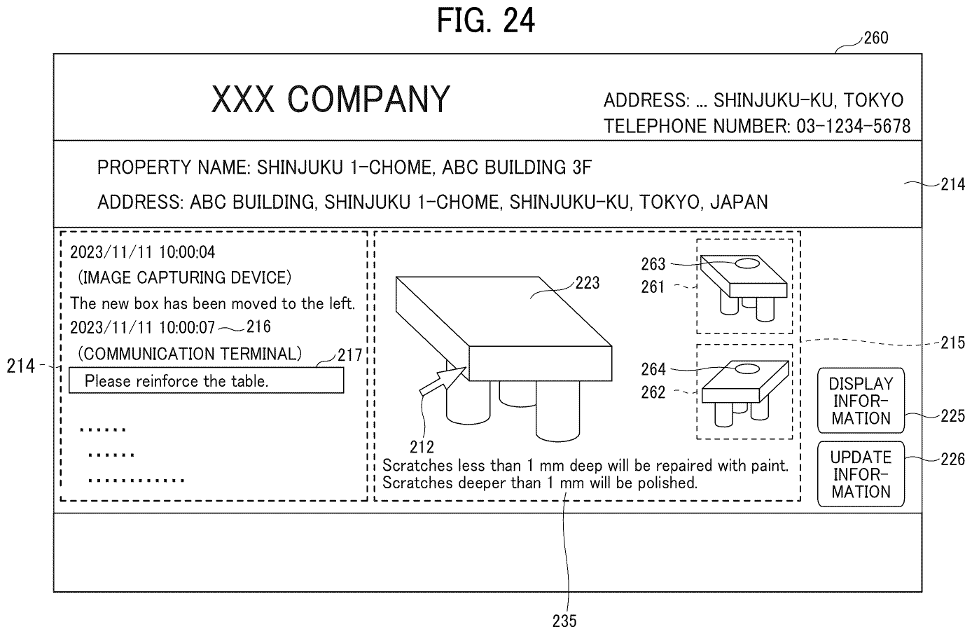

FIG. 24 is a diagram illustrating generated image information displayed on a text and image display screen 260. The following description of FIG. 24 focuses on the differences from FIG. 21.

Generated images 261 and 262 are displayed on the text and image display screen 260 in FIG. 24. The generated images 261 and 262 are not the captured image 237 and the past captured image 238 described above with reference to FIG. 21. The generated images 261 and 262 are generated by the image generation model 4007 based on the past captured image 238 and the text information 235. Accordingly, the generated images 261 and 262 have markers 263 and 264 indicating the position of a scratch, respectively. Instead of one of the generated images 261 and 262, the past captured image 238 may be displayed. Alternatively, the display of the generated image and the past captured image may be switched by a user operation.

### Effect of Generating Text Information Using Captured Image

An effect of generating text information using captured image, as in the present embodiment, is described below.

### 1. Comparative Example 1 (Case of Using Typical Large-Scale Language Model)

Question sentence: The user asks a question, “How can I repair cracks?”
Tacit knowledge-based comment: You can use tape or filler.

### 2. Comparative Example 2 (Case of Learning Three-Dimensional Image Information) Learning Phase

Learning data: The user asks, “How can I repair cracks?” while a three-dimensional image is displayed.
Input information: Please use tape for wide cracks and filler for narrow cracks.
Inference Phase
Input image: three-dimensional image information
Question sentence: “How can I repair cracks?”
Tacit knowledge-based comment: There are wide and narrow cracks, so it is recommended to use tape for the former and filler for the latter.

### 3. Present Embodiment (Three-Dimensional Image Information and Past Captured Image, Past Audio Transcript (Text))

Learning Phase Input image: three-dimensional image information and past captured image
Past audio transcript: Applying tape to the corner may cause cracks
Inference Phase
Input image: three-dimensional image information and past captured image
Question sentence: “How can i repair cracks?”
Tacit knowledge-based comment: There are wide and narrow cracks, so it is recommended to use tape for the former and filler for the latter. However, please apply tape carefully to corners, as applying tape to the corner may cause cracks.
Accordingly, “please apply tape carefully to corners, as applying tape to the corner may cause cracks” is an effect of having learned the past audio transcript.

### 4. Present Embodiment (Three-Dimensional Image Information, Past Captured Image, Past Audio Transcript (Text), and Input Information)

Learning Phase
Input image: three-dimensional image and past captured image
Past audio transcript: Applying tape to the corner may cause cracks
Input information: A wide crack extends across the corner.
Inference Phase
Input image: three-dimensional image information and past captured image
Question sentence: “How can i repair cracks?”
Tacit knowledge-based comment: There are wide and narrow cracks, so it is recommended to use tape for the former and filler for the latter. However, please apply tape carefully to corners, as applying tape to the corner may cause cracks.
Accordingly, “please apply tape carefully to corners, as applying tape to the corner may cause cracks” is an effect of having learned the past audio transcript.

### Multimodal

Several examples of combinations of input information and tacit knowledge-based comments are described below. Although the above-described model is a large-scale language model, a multimodal model may be used that receives data in multiple data formats, such as images, text, and gestures, and outputs the data in a predetermined data format.

In a case where the input information is string data presented as a text string and the content other than the text information is generated as a tacit knowledge comment, the text string is input to generate:
an image; a moving image;
audio; or
A 3D model.

In a case where the input information includes string data presented as a text string and non-string data, and the text information is generated as a tacit knowledge-based comment,
an image and the text string are input to generate text information;
a 3D model and the text string are input to generate text information; or
audio and the text string are input to generate text information.

In a case where the input information includes string data presented as a text string and non-string data, and the content other than the text information is generated as a tacit knowledge-based comment,
an image and the text string are input to generate an image;
a moving image and the text string are input to generate a moving image;
a 3D model and the text string are input to generate a 3D model; or
audio and the text string are input to generate audio.

The image management server 40 described above updates the tacit knowledge model with the three-dimensional image information, the captured image, and the audio transcript as the process based on at least one of the three-dimensional image information and the past captured image, and the past audio transcript. This allows the terminal device 10 to display the tacit knowledge-based comment corresponding to the at least one of the three-dimensional image information and the past captured image.

The above-described embodiments are illustrative and do not limit the present invention. Thus, numerous additional modifications and variations are possible in light of the above teachings without deviating from the scope of the present invention. The image management server 40 described above is merely one example, and various system configurations may be employed depending on the intended application or purpose.

Although examples in which the tacit knowledge models of the industry, such as civil engineering or construction, answer questions have been described, the tacit knowledge models may be used in any industry in which tacit knowledge is effective, such as medical care, dental care, and investment determination.

Although examples in which the large-scale language model 4005 generates text information based on tacit knowledge-based comments have been described, the tacit knowledge-based comments may be used as text information without using the large-scale language model 4005.

The tacit knowledge model 4004 may be trained to learn tacit knowledge-based comments using three-dimensional image information and audio transcript as inputs and using input information as an output. In other words, information in different forms, such as an image and text, may be input to the tacit knowledge model 4004.

Although the information processing systems 100, 100A, and 100B in a client-server configuration have been described, the function of the image management server 40 may be installed as an application in the terminal device 10. In other words, the functions described above may be made available to the user in a stand-alone manner.

In the configuration illustrated in, for example, FIG. 3, the processing by the image management server 40 is divided according to the main functions to facilitate understanding. The present disclosure is not limited by how the processing is divided or by the names of the processing units. The processing performed by the image management server 40 may be further divided into a greater number of processing units depending on the nature of the processing. Further, a single processing unit can be further divided into multiple processing units.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The group of apparatuses or devices described in the above-described embodiments is merely one example of multiple computing environments for implementing the embodiments disclosed herein. In one embodiment, the image management server 40 includes multiple computing devices, such as a server cluster. The computing devices are configured to communicate with each other via any type of communication link, including a network, shared memory, etc., and perform the processes disclosed in the above-described embodiment.

Further, the image management server 40 may combine the disclosed processing steps in various ways. Each component of the image management server 40 may be integrated into a single device or distributed across multiple devices. In addition, the processing performed by the image management server 40 may alternatively be carried out by the terminal device 10.

### Aspect 1

An information processing system according to Aspect 1 includes a first server, a second server, and a terminal device. The first server manages text data based on audio data obtained along with a captured image of a target object. The captured image is obtained by an image capturing device. The second server manages three-dimensional image information of the object and the captured image aligned with the three-dimensional image. The terminal device communicates with the first server and the second server.

The terminal device includes a display control unit to display a display screen including the text data received from the first server and the three-dimensional image information received from the second server.

The second server includes a processing unit to identify the captured image based on a field of view of the three-dimensional image information. The selection of the field of view is received at the terminal device.

The processing unit obtains the captured image from the first server, and associates the three-dimensional image information corresponding to the field of view with one of the text data and generated information generated based on the text data.

The display control unit of the terminal device displays the display screen including the three-dimensional image information and the one of the text data and the generated information that are received from the second server.

### Aspect 2

In the information processing system according to Aspect 1, the display control unit of the terminal device displays the display screen including a first display area displaying the text data received from the first server, and a second display area displaying the three-dimensional image information and the one of the text data and the generated information that are received from the second server.

### Aspect 3

In the information processing system according to Aspect 1 or Aspect 2, the second server stores, in a storage unit, the text data received from the first server in association with the captured image.

### Aspect 4

In the information processing system of Aspect 1, the processing unit requests the text data from the first server, and receives the text data from the first server as a response to the request.

### Aspect 5

In the information processing system according to any one of Aspect 1 to Aspect 4, the second server includes a model trained to learn a correspondence between the captured image identified based on the field of view of the three-dimensional image information, the three-dimensional image information corresponding to the field of view received at the terminal device, and the text data received from the first server.

The processing unit obtains the generated information being additional text data generated by the model based on the captured image and the three-dimensional image information corresponding to the field of view received at the terminal device.

### Aspect 6

In the information processing system according to any one of Aspect 1 to Aspect 4, the second server includes a model trained to learn a correspondence between the captured image identified based on the field of view of the three-dimensional image information, the three-dimensional image information of the field of view received at the terminal device, the text data received from the first server, and input information received from the terminal device. The field of view of the three-dimensional image information is received at the terminal device.

The processing unit obtains the generated information being additional text data generated by the model based on the captured image and the three-dimensional image information corresponding to the field of view received at the terminal device.

### Aspect 7

In the information processing system according to Aspect 5, the second server includes a update unit to cause the model to learn the correspondence between the captured image identified based on the field of view of the three-dimensional image information, the three-dimensional image information of the field of view received at the terminal device, and the text data received from the first server to update the model, the field of view of the three-dimensional image information being received at the terminal device.

### Aspect 8

In the information processing system according to Aspect 6, the second server circuitry is further configured to cause the model to learn the correspondence between the captured image identified based on the field of view of the three-dimensional image information, the three-dimensional image information of the field of view received at the terminal device, the text data received from the first server and input information received from the terminal device to update the model, the field of view of the three-dimensional image information being received at the terminal device.

### Aspect 9

In the information processing system according to any one of Aspect 1 to Aspect 8, the processing unit associates the text data obtained from the first server and the captured image identified based on the three-dimensional image information corresponding to the field of view received at the terminal device or associates the generated information and the captured image identified based on the three-dimensional image information corresponding to the field of view received at the terminal device.

The display control unit of the terminal device displays the display screen including the captured image and the one of the text data and the generated information that are received from the second server.

According to one aspect of the present disclosure, the process based on information managed by the first server and information managed by the second server can be performed without adding a processing function to the first server.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing system, comprising:
a first server to manage text data generated based on audio data obtained along with a captured image of a target object, the captured image being obtained by an image capturing device, the first server including first server circuitry;
a second server to manage three-dimensional image information of the target object and the captured image aligned with the three-dimensional image information, the second server including second server circuitry; and
a terminal device to communicate with the first server and the second server, the terminal device including terminal device circuitry configured to display, on a display screen, the text data received from the first server and the three-dimensional image information received from the second server,
the second server circuitry being configured to:
identify the captured image based on a field of view of the three-dimensional image information, the field of view being selected at the terminal device;
obtain, from the first server, the text data obtained along with the captured image; and
associate the three-dimensional image information corresponding to the field of view with one of the text data and generated information that is generated based on the text data,
the terminal device circuitry being configured to display, on the display screen, the three-dimensional image information and the one of the text data and the generated information in association with each other, the three-dimensional image information and the one of the text data and the generated information being received from the second server.

2. The information processing system of claim 1, wherein
the display screen includes a first display area for displaying the text data and a second display area for displaying the three-dimensional image information and the one of the text data and the generated information in association with each other.

3. The information processing system of claim 1, wherein
the second server circuitry is further configured to store, in a memory, the captured image in association with the text data received from the first server.

4. The information processing system of claim 1, wherein
the second server circuitry is further configured to:
transmit a request for the text data to the first server; and
obtain the text data from the first server as a response to the request.

5. The information processing system of claim 1, wherein
the second server further includes a memory that stores a model trained to learn a correspondence between the captured image, the three-dimensional image information, and the text data, the captured image being identified based on the field of view selected at the terminal device, the three-dimensional image information corresponding to the field of view selected at the terminal device, the text data being received from the first server, and
the second server circuitry is further configured to obtain the generated information being additional text data generated by the model based on the captured image and the three-dimensional image information corresponding to the field of view selected at the terminal device.

6. The information processing system of claim 1, wherein
the second server further includes a memory that stores a model trained to learn a correspondence between the captured image, the three-dimensional image information, the text data, and input information, the captured image being identified based on the field of view selected at the terminal device, the three-dimensional image information corresponding to the field of view selected at the terminal device, the text data being received from the first server, the input information being received from the terminal device, and
the second server circuitry is further configured to obtain the generated information being additional text data generated by the model based on the captured image and the three-dimensional image information corresponding to the field of view selected at the terminal device.

7. The information processing system of claim 5, wherein
the second server circuitry is further configured to cause the model to learn the correspondence between the captured image, the three-dimensional image information, and the text data to update the model.

8. The information processing system of claim 6, wherein
the second server circuitry is further configured to cause the model to learn the correspondence between the captured image, the three-dimensional image information, the text data, and the input information to update the model.

9. The information processing system of claim 1, wherein
the second server circuitry is further configured to associate the captured image identified based on the field of view of the three-dimensional image information with one of the text data obtained from the first server and the generated information, the field of view of the three-dimensional image information being selected at the terminal device, and
the terminal device circuitry is further configured to display, on the display screen, the three-dimensional image information, the captured image, and the one of the text data and the generated information in association with each other, the three-dimensional image information, the captured image, and the one of the text data and the generated information being received from the second server.

10. A server, comprising circuitry configured to:
store, in a memory, three-dimensional image information of a target object and a captured image aligned with the three-dimensional image information, the captured image being obtained by an image capturing device;
identify the captured image based on a field of view of the three-dimensional image information, the field of view being selected by a terminal device connected to the server;
obtain, from another server, text data obtained along with the captured image by the image capturing device;
associate the three-dimensional image information corresponding to the field of view with one of the text data and generated information that is generated based on the text data; and
transmit, to the terminal device, the three-dimensional image information and the one of the text data and the generated information, the three-dimensional image information and the one of the text data and the generated information being to be displayed in association with each other on a display screen of the terminal device.

11. An information processing method performed by a server, comprising:
storing, in a memory, three-dimensional image information of a target object and a captured image aligned with the three-dimensional image information, the captured image being obtained by an image capturing device;
identifying the captured image based on a field of view of the three-dimensional image information, the field of view being selected at a terminal device communicably connected to the server;
obtaining, from another server, text data, the text data being obtained along with the captured image by the image capturing device;
associating the three-dimensional image information corresponding to the field of view with one of the text data and generated information that is generated based on the text data; and
transmitting, to the terminal device, the three-dimensional image information and the one of the text data and the generated information, the three-dimensional image information and the one of the text data and the generated information being to be displayed in association with each other on a display screen of the terminal device.

12. A non-transitory recording medium storing a plurality of instructions which, when executed by one or more processors, causes the one or more processors to perform a method, the method comprising:
storing, in a memory, three-dimensional image information of a target object and a captured image aligned with the three-dimensional image information, the captured image being obtained by an image capturing device;
identifying the captured image based on a field of view of the three-dimensional image information, the field of view being selected at a terminal device;
obtaining, from a server, text data, the text data being obtained along with the captured image by the image capturing device;
associating the three-dimensional image information corresponding to the field of view with one of the text data and generated information that is generated based on the text data; and
transmitting, to the terminal device, the three-dimensional image information and the one of the text data and the generated information, the three-dimensional image information and the one of the text data and the generated information being to be displayed in association with each other on a display screen of the terminal device.
